(19) United States
(12) Patent Application Publication
(10) Pub. No.: US 2016/0077597 A1
(43) Pub. Date: Mar. 17, 2016

(54) INPUT DEVICE AND METHOD FOR INPUTTING OPERATIONAL REQUEST

(71) Applicant: Panasonic Intellectual Property Corporation of America, Torrance, CA (US)

(72) Inventors: Nawatt SILAWAN, Osaka (JP); Yoichi IKEDA, Hyogo (JP)

(21) Appl. No.: 14/891,048

(22) PCT Filed: May 26, 2014
(86) PCT No.: PCT/JP2014/002766

§ 371 Date: Nov. 13, 2015

(30) Foreign Application Priority Data
Jun. 18, 2013 (JP) 2013-127384

(51) Int. Cl. G06F 3/01; G06F 3/0346; G06F 3/041

(52) U.S. Cl. CPC G06F 3/017; G06F 3/016; G06F 3/041; G06F 3/0346

(57) ABSTRACT

The present application discloses an input device including a sensor configured to track movement of a body part of an operator and generate movement data about the movement of the body part, a processor including an operation command generator configured to generate an operation command from the movement data, a speed data generator configured to generate speed data representing a speed of the movement from the movement data, and a feedback determination portion configured to determine whether a feedback operation to allow the operator to confirm the operation command is required based on the speed data, and an operation portion including a feedback operation device configured to execute the feedback operation if the feedback determination portion determines that the feedback operation is required.

### TECHNICAL FIELD

The present invention relates to an input device and a method which are used for inputting an operational request.

### BACKGROUND ART

There are various technologies to input operational requests to various apparatuses. The apparatuses operate in response to the operational requests.

An operator may touch and operate an input knob to input operational request to an apparatus. For example, an operator turns a knob of a radio device to adjust a sound volume.

An operator may operate a remote controller for wireless control to an apparatus. For example, an operator uses a remote controller to input a desired television program to a television set.

An operator may use a mouse device that may include a mechanical computer mouse, an optical computer mouse or other pointer devices such as pen or stylus to input operational request to an apparatus. For example, an operator uses an optical computer mouse to select ‘save’ symbol on a computer screen to save an edited document.

An operator may touch a touchscreen device to input an operational request to an apparatus. For example, an operator touches an arrow sign displayed on a touchscreen device to adjust brightness of the touchscreen.

An operator may sometimes want to input an operational request to an apparatus without touching anything. For example, it may be convenient for an operator if the operator makes an air gesture by hand to input the operational request when the hand is dirty.

The technologies disclosed in Patent Document 1 an operator to input an operational request by means of an air gesture.

The technologies of Patent Document 1 feedback operations which allow an operator to confirm whether selected menus are executed. However, feedback operations are not always required. For example, if an operator becomes familiar with operating an apparatus, the operator may not need any feedback operation. Occasionally, a feedback operation may interfere with a smooth input operation to an apparatus.

The technologies disclosed in Patent Document 2 allow operator to input an operational request by means of a gesture via various types of mouse devices that may include a mechanical computer mouse, an optical computer mouse or other pointer devices such as pen, stylus and touchscreen device.

The technologies of Patent Document 2 teach feedback operation to guide an operator who is not skilled in gesture operation to complete the gesture operation properly. In Patent Document 2 , the guiding feedback will be done if the operator cannot finish gesture operation in set time limit. In addition, the technologies of Patent Document 2 also teach feedback operation to just inform an operator a decided operation command.

However, especially for air gesture operation, error in gesture recognition can be occurred easily in the case that there is no display screen, which displays present input gesture condition, and the operator has to perform an air gesture from the start to the end without visualized feedback. In addition, limitations of a sensor used for detecting a gesture may also cause error in gesture recognition. Those limitations may be limited field of view, limited sensing range and distance, distortion of sensing signals inside air medium, or noises. The error in gesture recognition may cause system instability and may cause the operator inconvenience.

[Patent Document 1] JPH07-334299 A

[Patent Document 2] US 2012/0124472 A 1

### SUMMARY OF INVENTION

The present invention aims to provide technologies which selectively execute a feedback operation to notify an operator of a device status.

The input device according to one aspect of the present invention includes a sensor configured to track movement of a body part of an operator and generate movement data about the movement of the body part, a processor including an operation command generator configured to generate an operation command from the movement data, a speed data generator configured to generate speed data representing a speed of the movement from the movement data, and a feedback determination portion configured to determine whether a feedback operation to allow the operator to confirm the operation command is required based on the speed data, and an operation portion including a feedback operation device configured to execute the feedback operation if the feedback determination portion determines that the feedback operation is required.

The method according to another aspect of the present invention is used for inputting an operational request. The method includes steps of tracking movement of a body part of an operator to generate movement data about the movement of the body part, generating an operation command defining a predetermined operation and speed data representing a speed of the movement from the movement data, determining whether a feedback operation to allow the operator to confirm the operation command is required based on the speed data, and executing the feedback operation if the feedback operation is required.

The technologies of the present invention may selectively cause a feedback operation to notify an operator of a device status.

### BRIEF DESCRIPTION OF DRAWINGS

FIG. 1 is a schematic block diagram of the input device according to the first embodiment.

FIG. 2 is a schematic block diagram showing an exemplary hardware configuration of the input device depicted in FIG. 1.

FIG. 3 is a schematic block diagram showing an exemplary hardware configuration of the input device according to the second embodiment.

FIG. 4 is an exemplary functional block diagram of the input device according to the third embodiment.

FIG. 5 is a schematic flowchart of processes of the input device shown in FIG. 4.

FIG. 6 shows an exemplary piece of image data generated by a motion detector of the input device depicted in FIG. 4.

FIG. 7A shows a series of images represented by the image data depicted in FIG. 6.

FIG. 7B shows data recognized by a gesture recognition block of the input device depicted in FIG. 4.

FIG. 8A shows a series of images representing other movement of the hand.

FIG. 8B shows exemplary movement of the hand turning an imaginary knob.

FIG. 9 shows an exemplary data structure of vector data generated by the gesture recognition block.

FIG. 10 is an exemplary functional block diagram of the input device according to the fourth embodiment.

FIG. 11 is an exemplary functional block diagram of the input device according to the fifth embodiment.

FIG. 12 is an exemplary functional block diagram of the input device according to the sixth embodiment.

FIG. 13 is a schematic flowchart of processes of the input device shown in FIG. 12.

FIG. 14 is another schematic flowchart of processes of the input device shown in FIG. 12.

FIG. 15A shows an exemplary gesture pattern.

FIG. 15B shows another exemplary gesture pattern.

FIG. 16 is a conceptual view of generation of pattern data.

FIG. 17 is a conceptual view of data structure of command group data stored in a second storage of the input device shown in FIG. 12.

FIG. 18 is a conceptual view of time data incorporated into the pattern data.

FIG. 19 is a conceptual view of a data structure of candidate data stored in a third storage of the input device shown in FIG. 12.

FIG. 20A is a schematic perspective view of a hand gesture making a start gesture.

FIG. 20B shows a three-dimensional coordination system.

FIG. 21 is a schematic perspective view of another hand gesture making the start gesture.

FIG. 22 is an exemplary functional block diagram of the input device according to the seventh embodiment.

FIG. 23 is a schematic flowchart of processes of an output controller of the input device shown in FIG. 22.

FIG. 24A is a schematic perspective view of the cooking heater according to the eighth embodiment

FIG. 24B shows an operator using the cooking heater shown in FIG. 24A.

FIG. 25A shows an exemplary gesture pattern to increase a heating level.

FIG. 25B shows another exemplary gesture pattern to decrease a heating level.

FIG. 26 is an exemplary functional block diagram of the input device according to the ninth embodiment.

FIG. 27 is a schematic flowchart of processes of the input device shown in FIG. 26.

FIG. 28 is an exemplary functional block diagram of the input device according to the tenth embodiment.

FIG. 29 shows an exemplary gesture pattern including four steps performed with different speed.

FIG. 30 shows exemplary gesture patterns including performed gesture pattern and alternative gesture patterns in alternative operation command prediction.

### DESCRIPTION OF EMBODIMENTS

Various embodiments about input technologies are described below with reference to the accompanying drawings. Principles of the input technologies can be clearly understood by the following description. Directional terms such as “up”, “down”, “right”, “left” and so on are used to make the description clear. Therefore, these terms should not be restrictively interpreted.

### First Embodiment

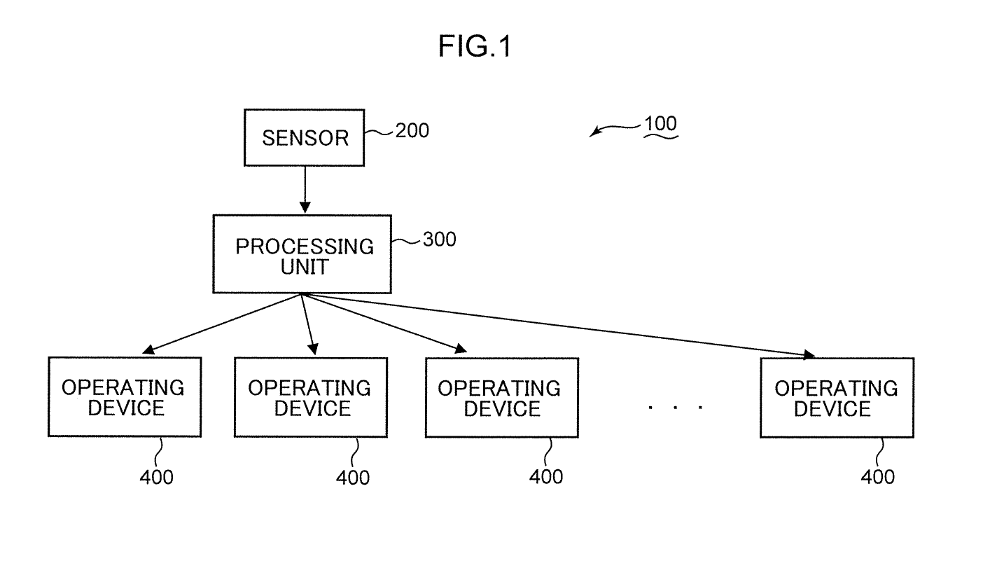

FIG. 1 is a schematic block diagram of an exemplary input device 100. The input device 100 is described with reference to FIG. 1.

The input device 100 includes a sensor 200, a processing unit 300 and several operating devices 400. An operator may make a gesture, for example, by hand in front of the sensor 200. The sensor 200 tracks movement of the hand, and then generates movement data representing the movement of the hand. In this embodiment, the hand of the operator is exemplified as the body part. Alternatively, the sensor 200 may track movement of other body parts of an operator.

The movement data is transmitted from the sensor 200 to the processing unit 300. The movement data may be image data representing the movement of the hand. Alternatively, other types of data representing movement of a body part of an operator may be used as the movement data. If image data is used as the movement data, the sensor 200 may be a camera or other devices configured to capture the movement of the hand.

The processing unit 300 has several functions such as a command generation function to generate operation commands, a data generation function to generate speed data representing a speed of the movement of the hand and a determination function to determine whether a feedback operation is required or not. At least one of the operating devices 400 executes a predetermined operation in response to an operation command. For example, if one of the operating devices 400 is a heater and if the processing unit 300 generates an operation command which instructs an increase in a heating level, the heater increases a heating level. In this embodiment, a group of the operating devices 400 shown in FIG. 1 are exemplified as the operation portion. At least one of the operating devices 400 is exemplified as the command execution device.

At least another of the operating devices 400 executes a feedback operation if the processing unit 300 determines that the feedback operation is required. For example, if one of the operating devices 400 is a lamp configured to notify an operator of an increase in a heating level, the lamp may blink when the processing unit 300 determines that the feedback operation is required for an operation command instructing an increase in a heating level. Accordingly, the operator may see the blinking lamp and confirm contents of the operation command that a heating function of an apparatus into which the input device 100 is incorporated becomes active. In this embodiment, at least one of the operating devices 400 is exemplified as the feedback operation device.

It may depend on the speed data generated by the processing unit 300 whether the feedback operation is required or not. If an operator is unfamiliar with air gestures for the input device 100, the operator is likely to move the hand slowly. In this case, the operator often needs and/or wants to confirm whether an operational request is appropriately input to the input device 100. Unless the aforementioned lamp blinks when the operator makes a gesture in the air by hand, the operator may know that the air gesture is not appropriately received by the input device 100, and then the operator may retry the air gesture. Therefore, the processing unit 300 may determine that the feedback operation is required if the operator moves the hand at a lower speed than a threshold. If the operator is very familiar with air gestures for the input device 100, the operator may appropriately and quickly input an operational request to the input device 100 without any support of the feedback operation. Therefore, the processing unit 300 may determine that there is no requirement of the feedback operation if the operator moves the hand at a speed no lower than the threshold. In this embodiment, the processing unit 300 is exemplified as the processor.

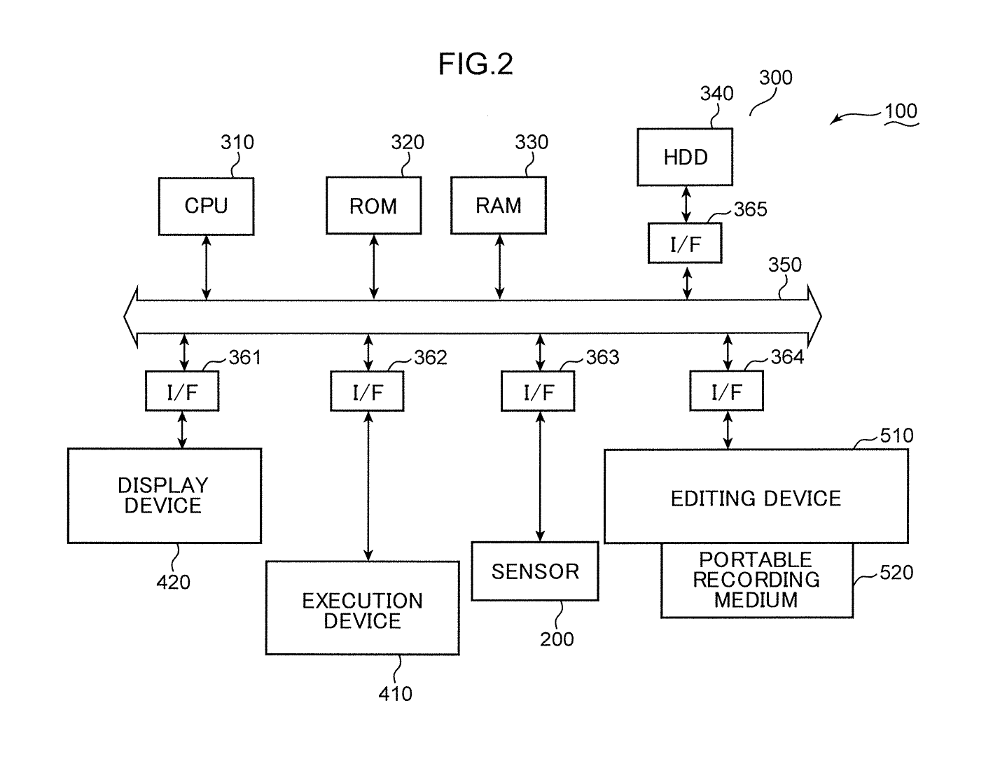

FIG. 2 is a schematic block diagram showing an exemplary hardware configuration of the input device 100. The input device 100 is further described with reference to FIGS. 1 and 2.

The input device 100 receives operational requests from an operator. The operational requests are processed by the processing unit 300, and then transmitted to at least one of the operating devices 400 such as a home electronic appliance, an audio-video machine, a tablet, a mobile communication terminal and so on. The input device 100 may be integrated into or separated from the at least one of the operating devices 400. In FIG. 2, the operating device 400 working as a home electronic appliance, an audio-video machine, a tablet, a mobile communication terminal or alike is depicted as the execution device 410.

The processing unit 300 includes CPU (Central Processing Unit) 310, ROM (Read Only Memory) 320, RAM (Random Access Memory) 330, HDD (Hard Disk Drive) 340, bus line 350 and interfaces (denoted as “I/F” in FIG. 2) 361, 362, 363, 364, 365. ROM 320 keeps fixed computer programs and data which define operations of the execution device 410. The HDD 340 keeps other computer programs and content data. If the execution device 410 is a navigation system, the content data in the HDD 340 may be map data. If the execution device 410 is a music player, the content data in the HDD 340 may be music data. Alternatively, the content data for various applications (e.g. navigating application or music player application) may be stored in the RAM 330 if the RAM 330 is nonvolatile.

Some of the computer programs stored in ROM 320 and/or HDD 340 may realize the aforementioned various functions (command generation function, data generation function and determination function). In this embodiment, the computer programs configured to realize the command generation function are exemplified as the operation command generator. The computer programs configured to realize the data generation function are exemplified as the speed data generator. The computer programs configured to realize the determination function are exemplified as the feedback determination portion.

The CPU 310, the ROM 320 and the RAM 330 are connected to the bus line 350. The HDD 340 is connected to the bus line 350 through the interface 365. The execution device 410 is connected to the bus line 350 through the interface 362. The CPU 310 reads computer programs and data from the ROM 320 and the HDD 340 through the bus line 350 and the interface 365 to generate operation commands. The operation commands are sent from the CPU 310 to the execution device 410 through the bus line 350 and the interface 362. The execution device 410 may execute various operations in response to the operation commands. The RAM 330 may temporarily store computer programs and data during the operation command generation and/or other processes of the CPU 310. The ROM 320 and the RAM 330 may be a flash memory writable nonvolatile memory or recording medium. In this embodiment, the CPU 310 is a single CPU. Alternatively, several CPUs may be used in the input device 100.

The sensor 200 is connected to the bus line 350 through the interface 363. The sensor 200 generates the movement data as described with reference to FIG. 1. The movement data may be sent from the sensor 200 to the RAM 330 through the interface 363 and the bus line 350. The CPU 310 executing the computer programs for the command generation function, the data generation function, and the determination function reads the movement data from the RAM 330. The CPU 310 generates operation commands from the movement data when the CPU 310 executes the computer programs for the command generation function. The operation commands are output from the CPU 310 to the execution device 410 through the bus line 350 and the interface 362. The CPU 310 generates speed data from the movement data when the CPU 310 executes the computer programs for the data generation function. The CPU 310 then determines whether a feedback operation is required or not, on the basis of the speed data when the CPU 310 executes the computer programs for the determination function. In this embodiment, the execution device 410 is exemplified as the command execution device.

One of the operating devices 400 shown in FIG. 1 may correspond to the display device 420 in FIG. 2. As shown in FIG. 2, the display device 420 is connected to the bus line 350 through the interface 361. The display device 420 displays information to communicate with an operator. The display device 420 may be an LCD (Liquid Crystal Display) or another device configured to display communicative information. In this embodiment, the display device 420 is exemplified as the feedback operation device.

If the CPU 310 determines that a feedback operation is required, the CPU 310 generates a feedback request command. The feedback request command is output from the CPU 310 to the display device 420 through the bus line 350 and the interface 361. The display device 420 receiving the feedback request command may display information about an operation of the execution device 410 in response to an operation command. Accordingly, an operator may know whether the input device 100 receives an operational request from the operator appropriately. If the display device 420 is configured as a touch panel, the operator may operate the touch panel to cancel the operational request. In this embodiment, the display operation of the display device 420 is exemplified as the notification operation.

The input device 100 may further include an editing device 510 and a portable recording medium 520. The editing device 510 is connected to the bus line 350 through the interface 364. The portable recording medium 520 may store content data and computer programs. The portable recording medium 520 may be SD, CD, BD, memory card or another memory device configured to keep content data and/or computer programs. The editing device 510 reads the content data from the portable recording medium 520. The content data may be then output from the editing device 510 to the RAM 330 and/or HDD 340. The CPU 310 may use the content data for various data processes. Optionally, the display device 420 may display the content data as an editing menu. An operator may watch the editing menu on the display device 420 and operates the editing device 510 to edit the content data.

The content data may contain criteria information for the determination function. The CPU 310 executing the computer programs for the determination function may refer the criteria information to determine whether a feedback operation is required or not. The operator may edit the content data in the portable recording medium 520 to change the criteria of the determination function. The editing device 510 may overwrite the edited content data to the portable recording medium 520.

### Second Embodiment

The sensor to take movement data of a body part of an operator may be shared by the input device and other systems. In the context of the second embodiment, the input device utilizes a sensor as a part of a home control system configured to control various domestic appliances.

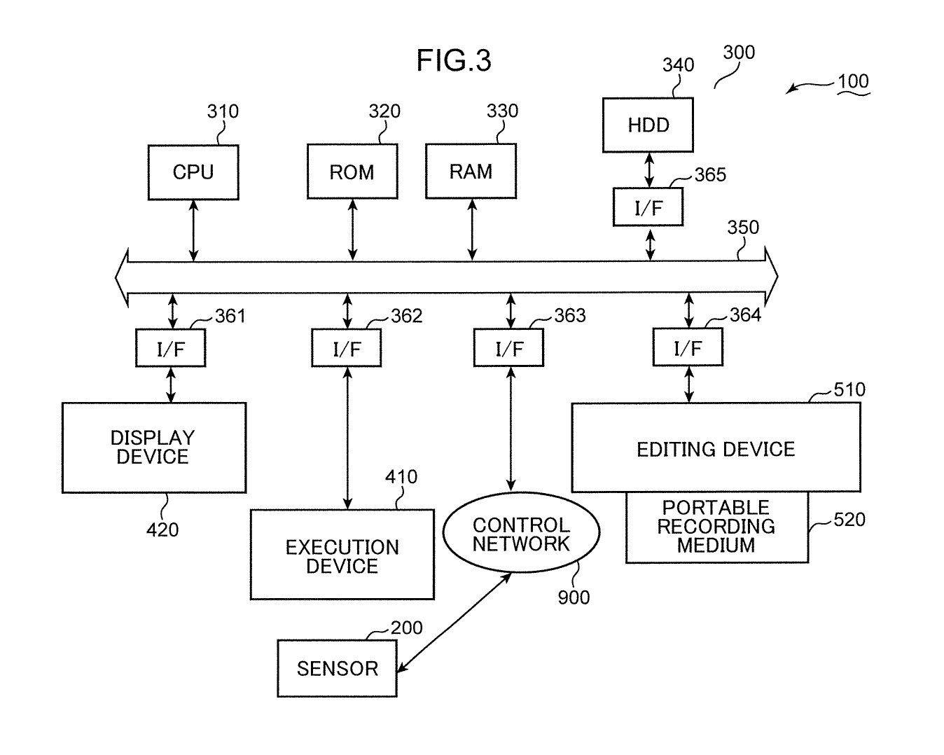

FIG. 3 is a schematic block diagram showing another exemplary hardware configuration of the input device 100. The hardware configuration of the input device 100 is described with reference to FIGS. 1 and 3. It should be noted that the commonly used numerals between FIGS. 2 and 3 mean that elements labeled with the common numerals have the same functions as the first embodiment. Therefore, the description in the first embodiment is applied to these elements.

Like the first embodiment, the input device 100 includes the sensor 200, the processing unit 300, the display device 420, the execution device 410, the editing device 510 and the portable recording medium 520. The input device 100 communicates with a control network 900 configured to control various domestic appliances such as an air conditioner, a television set, cooking appliances and so on. The sensor 200 is shared by the input device 100 and the control network 900. The movement data generated by the sensor 200 may be used not only by the input device 100 but also the control network 900. The sensor 200 is connected to the control network 900. The control network 900 is connected to the interface 363 of the processing unit 300. The movement data is sent from the sensor 200 to the RAM 330 through the control network 900, the interface 363 and the bus line 350.

The control network 900 may be used for feeding the CPU 310 computer programs. The computer programs may be sent from the control network 900 to the RAM 330 and/or the HDD 340 through the interface 363 and the bus line 350. The CPU 310 may read and execute the computer programs stored in the RAM 330 and/or the HDD 340. The data transmission from the control network 900 to the input device 100 may be a wired manner or a wireless manner.

### Third Embodiment

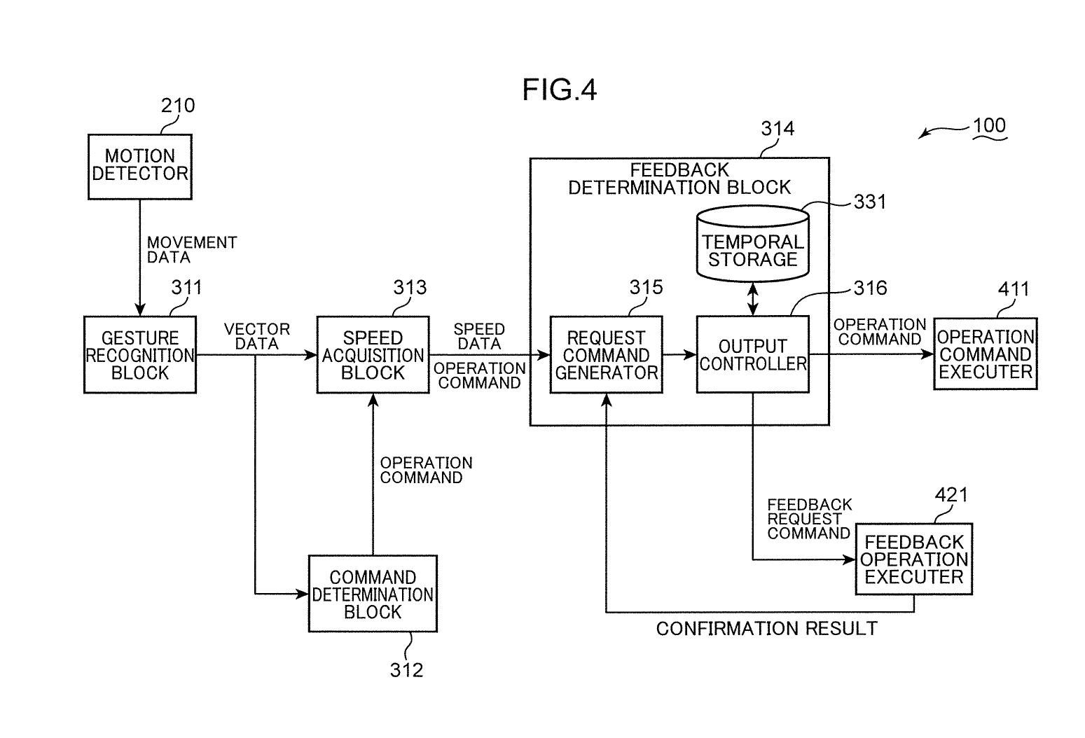

FIG. 4 is an exemplary functional block diagram of the input device 100. The functional block diagram is designed on the basis of the technical concepts described in the context of the first embodiment. Functions of the input device 100 are described in the context of the third embodiment with reference to FIGS. 1, 2 and 4.

The input device 100 includes a motion detector 210, a gesture recognition block 311, a command determination block 312, a speed acquisition block 313, a feedback determination block 314, an operation command executer 411 and a feedback operation executer 421. The motion detector 210 detects movement of a body part of an operator. The motion detector 210 then generates image data representing the movement of the body part as the movement data. The motion detector 210 corresponds to the sensor 200 described in the context of the first embodiment.

The image data is output from the motion detector 210 to the gesture recognition block 311. The gesture recognition block 311 recognizes a part of the image data as gesture data which represents characteristics of the motion of the body part. The gesture recognition block 311 may use known image recognition technologies to recognize the gesture data. The gesture recognition block 311 corresponds to the CPU 310 executing computer programs configured to recognize specific images in image data. In this embodiment, the gesture recognition block 311 is exemplified as the recognition portion.

The gesture recognition block 311 then extracts the gesture data from the image data. The gesture data is output from the gesture recognition block 311 to the command determination block 312 and the speed acquisition block 313 as vector data.

The command determination block 312 identifies a movement pattern from the vector data. If the vector data shows a straight trail of the body part, the command determination block 312 may determine a specific operation command (e.g. operation command instructing an increase in a heating level) corresponding the straight trail. If the vector data shows a whirl trail of the body part, the command determination block 312 may determine another specific operation command (e.g. operation command instructing a decrease in a heating level) corresponding the whirl trail. The command determination block 312 corresponds to the CPU 310 executing computer programs for the command generation function described in the context of the first embodiment. These operation commands are output from the command determination block 312 to the speed acquisition block 313. In this embodiment, the command determination block 312 is exemplified as the operation command generator.

Once the speed acquisition block 313 receives an operation command from the command determination block 312, the speed acquisition block 313 generates speed data from the vector data. The vector data may contain time data representing a time length from a start point, at which the body part starts moving, to an end point, at which the body part stops moving. The speed acquisition block 313 may measure a total length of a vector represented by the vector data. The speed acquisition block 313 may acquire speed data from the time length and the total vector length. A set of the speed data and the operation command is then output from the speed acquisition block 313 to the feedback determination block 314. The speed acquisition block 313 corresponds to the CPU 310 executing computer programs for the data generation function described in the context of the first embodiment. In this embodiment, the speed acquisition block 313 is exemplified as the speed data generator.

The feedback determination block 314 includes a request command generator 315, an output controller 316 and a temporal storage 331. The speed data and the operation command are input to the request command generator 315. The request command generator 315 determines whether a feedback operation is required or not on the basis of the speed data and the operation command. If the operation command indicates an operation which requires a feedback operation and if the request command generator 315 identifies that the speed data shows a lower speed than a threshold as a result of a comparison between the speed data and the threshold, the request command generator 315 generates a feedback request command which indicates requirement of the feedback operation. The request command generator 315 outputs the feedback request command and the operation command to the output controller 316. The request command generator 315 then makes the output controller 316 send the operation command to the temporal storage 331 and the feedback request command to the feedback operation executer 421. If the operation command indicates another operation which requires no feedback operation or if the speed data shows a speed no lower than the threshold, the request command generator 315 outputs the operation command to the output controller 316. The request command generator 315 then makes the output controller 316 transmit the operation command to the operation command executer 411. The request command generator 315 corresponds to the CPU 310 executing computer programs for the determination function described in the context of the first embodiment. The temporal storage 331 corresponds to the RAM 330 and/or the HDD 340. In this embodiment, the feedback determination block 314 is exemplified as the feedback determination portion.

Once the feedback operation executer 421 receives the feedback request command, the feedback operation executer 421 executes a feedback operation. The feedback operation executer 421 corresponds to at least one of the operating devices 400 in FIG. 1 (e.g. display device 420 in FIG. 2). The feedback operation executer 421 is configured to receive an input from the operator. The operator may operate the feedback operation executer 421 for further processes when the operator confirms that the input device 100 appropriately receives an operational request from the operator. Otherwise, the operator may operate the feedback operation executer 421 to stop or cancel further processes. The feedback operation executer 421 generates a confirmation result in response to the input from the operator. The confirmation result is output from the feedback operation executer 421 to the request command generator 315. In this embodiment, the feedback operation executer 421 is exemplified as the feedback operation device.

Once the request command generator 315 receives the confirmation result from the feedback operation executer 421 and if the confirmation result indicates a request of further processes, the request command generator 315 makes the output controller 316 read the operation command from the temporal storage 331. The operation command is then output from the output controller 316 to the operation command executer 411. Unless the confirmation result indicates a request of further processes, the input device 100 abandons the data processes and waits for detection of new movement of the body part by the motion detector 210.

If the operation command indicates an operation which requires a feedback operation and if the speed data shows a lower speed than the threshold, the operation command executer 411 executes the operation defined by the operation command after the feedback operation. If the operation command indicates an operation which requires no feedback operation or unless the speed data shows a lower speed than the threshold, the operation command executer 411 executes the operation defined by the operation command without waiting for a feedback operation. The operation command executer 411 corresponds to one of the operating devices 400 in FIG. 1 (e.g. the execution device 410 in FIG. 2). In this embodiment, the operation command executer 411 is exemplified as the command execution device.

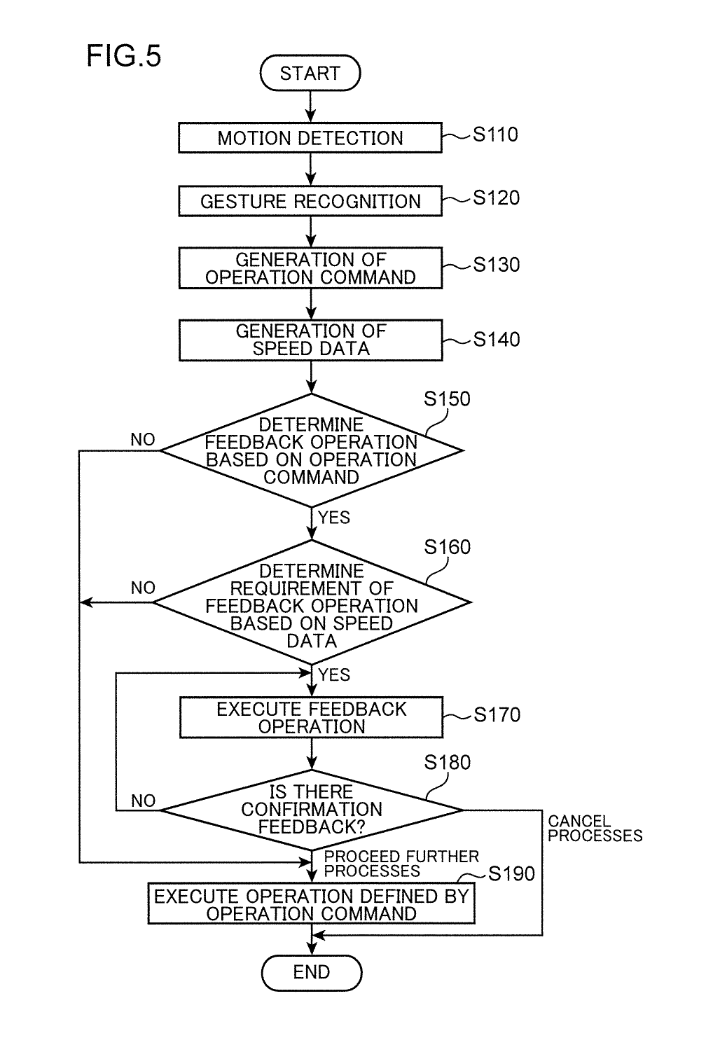

FIG. 5 is a schematic flowchart of processes of the input device 100. The flowchart is designed on the basis of the configuration described with reference to FIG. 4. The processes of the input device 100 are described with reference to FIGS. 4 and 5. It should be noted that the flowchart in FIG. 5 is just exemplary. Therefore, the input device 100 may execute various subsidiary processes in addition to the steps in FIG. 5.

### (Step S110)

In step S110, the motion detector 210 detects movement of a body part of an operator. The motion detector 210 then generates image data as the movement data representing the motion of the operator. The image data is output from the motion detector 210 to the gesture recognition block 311. After that, step S120 is executed.

### (Step S120)

In step S120, the gesture recognition block 311 recognizes a part of data as data of the body part and generates vector data from the recognized data part. The vector data is sent from the gesture recognition block 311 to the command determination block 312 and the speed acquisition block 313. After that, step S130 is executed.

### (Step S130)

In step S130, the command determination block 312 determines an operation command on the basis of the vector data. The operation command generated by the command determination block 312 is then output to the speed acquisition block 313. After that, step S140 is executed.

### (Step S140)

In step S140, the speed acquisition block 313 generates speed data representing a speed of the body part from the vector data. The speed acquisition block 313 outputs the speed data and the operation command to the request command generator 315. After that, step S150 is executed.

### (Step S150)

In step S150, the request command generator 315 refers the operation command and determines whether an operation defined by the operation command requires a feedback operation. If the operation requires a feedback operation, step S160 is executed. Otherwise, step S190 is executed.

### (Step S160)

In step S160, the request command generator 315 compares a speed represented by the speed data with a threshold. If the speed is lower than the threshold, the request command generator 315 determines that a feedback operation is required. The request command generator 315 then generates a feedback request command. The feedback request command is output from the request command generator 315 to the feedback operation executer 421 through the output controller 316. The operation command is output from the request command generator 315 to the temporal storage 331 through the output controller 316. After that, step S170 is executed. Unless the speed is lower than the threshold, the request command generator 315 determines that no feedback operation is required. The request command generator 315 outputs the operation command to the operation command executer 411 through the output controller 316. After that, step S190 is executed.

### (Step S170)

In step S170, the feedback operation executer 421 executes the feedback operation in response to the feedback request command. Accordingly, the operator may confirm whether the input device 100 receives an operational request from the operator appropriately or not. After that, step S180 is executed.

### (Step S180)

In step S180, the request command generator 315 waits for a feedback input from the operator. If the operator operates the feedback operation executer 421 to request further processes, step S190 is executed. If the operator operates the feedback operation executer 421 to cancel processes, the input device 100 stops processes.

### (Step S190)

In step S190, the operation command executer 411 executes a predetermined operation in response to the operation command.

### (Gesture Recognition)

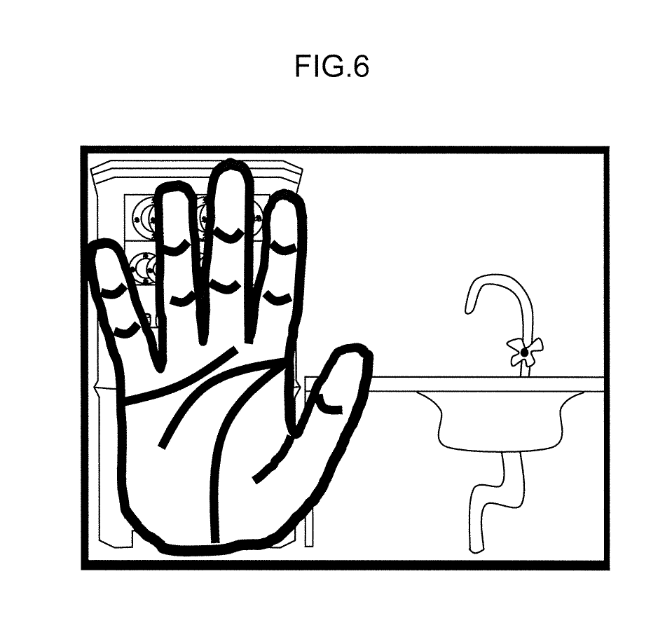

FIG. 6 shows an exemplary piece of image data generated by the motion detector 210. The gesture recognition of step S110 is described with reference to FIGS. 4 to 6.

The image data in FIG. 6 shows the hand of an operator and furniture as a background. The gesture recognition block 311 recognizes the hand as a body part making a gesture for giving input information about an operational request.

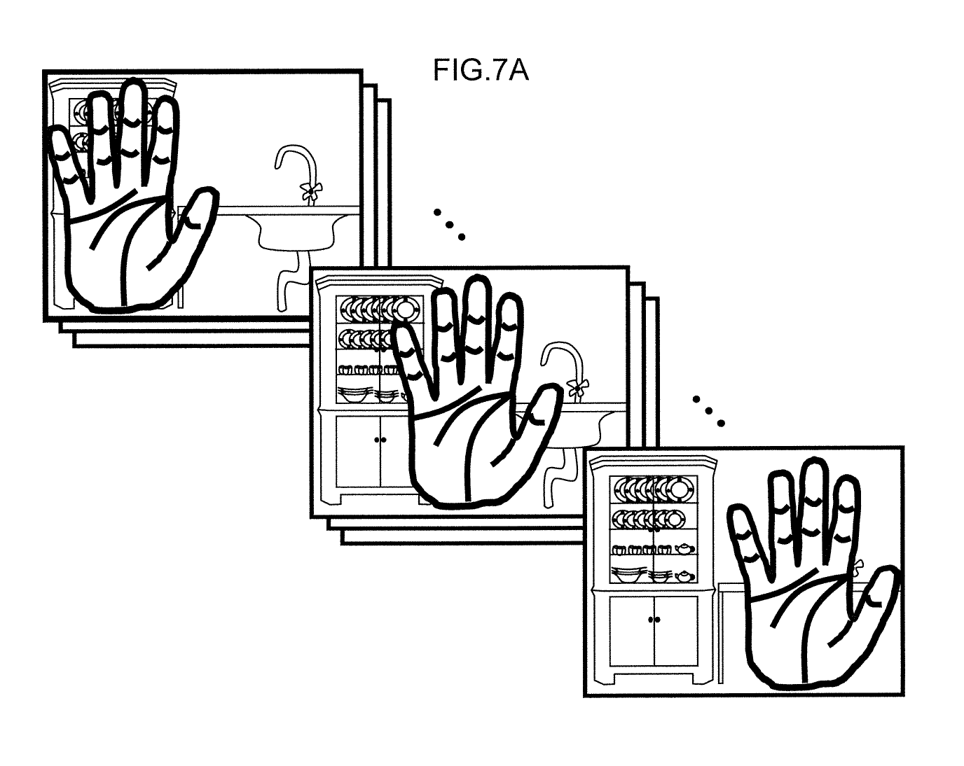

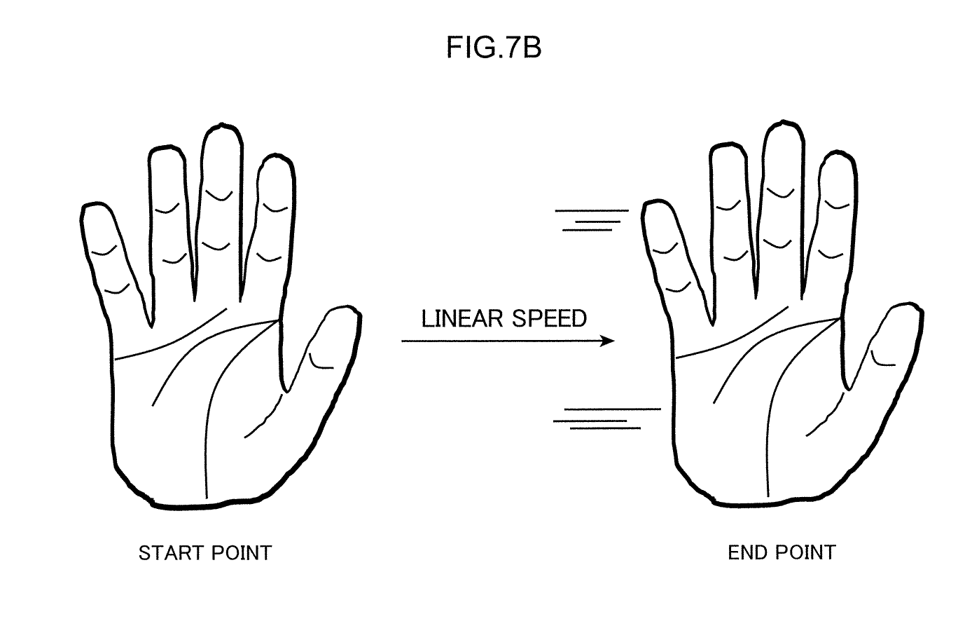

FIG. 7A shows a series of images represented by the image data depicted in FIG. 6. FIG. 7B shows data recognized by the gesture recognition block 311. The gesture recognition of step S110 is further described with reference to FIGS. 4 to 7B.

While the operator moves the hand horizontally as shown in FIG. 7A, the motion detector 210 generates image data representing the horizontal movement. The gesture recognition block 311 extracts a data part representing the hand from the image data. Therefore, the gesture recognition block 311 recognizes the hand moving from the left to the right, as shown in FIG. 7B.

When a condition of the hand in the recognized data changes from an immobile condition to a moving condition, the gesture recognition block 311 recognizes the hand position of the conditional change as the start point. When a condition of the hand in the recognized data changes from the moving condition to another immobile condition, the gesture recognition block 311 recognizes the hand position of the condition change as the end point.

The gesture recognition block 311 generates vector data representing a vector which horizontally extends from the start point to the end point. The gesture recognition block 311 may put time information about how long it takes for the hand to move from the start point to the end point, into the vector data.

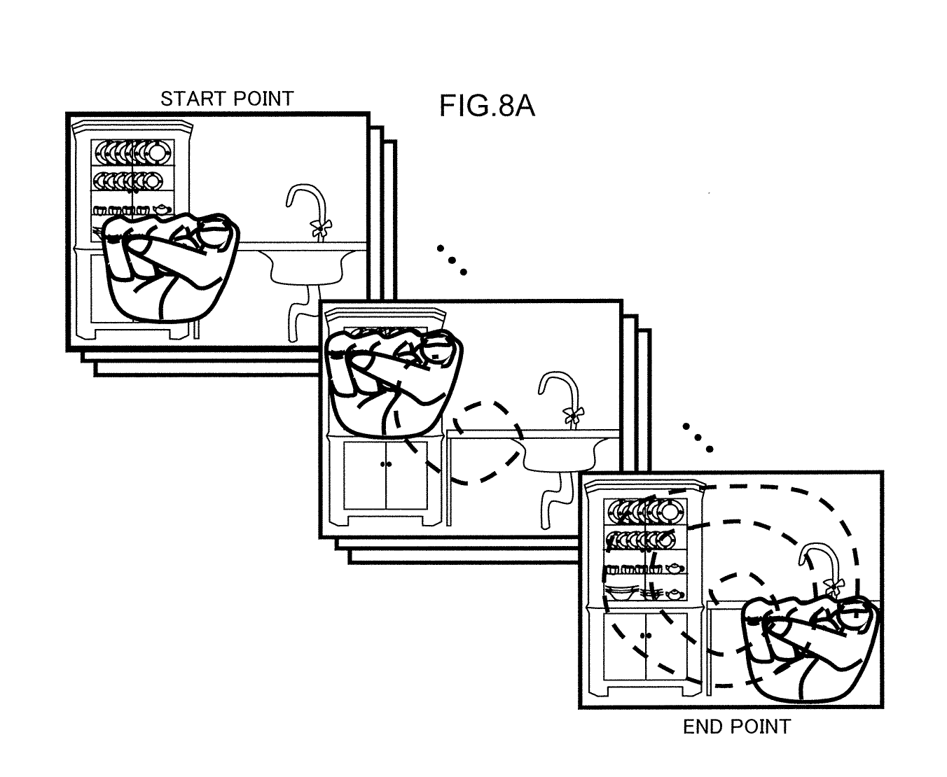

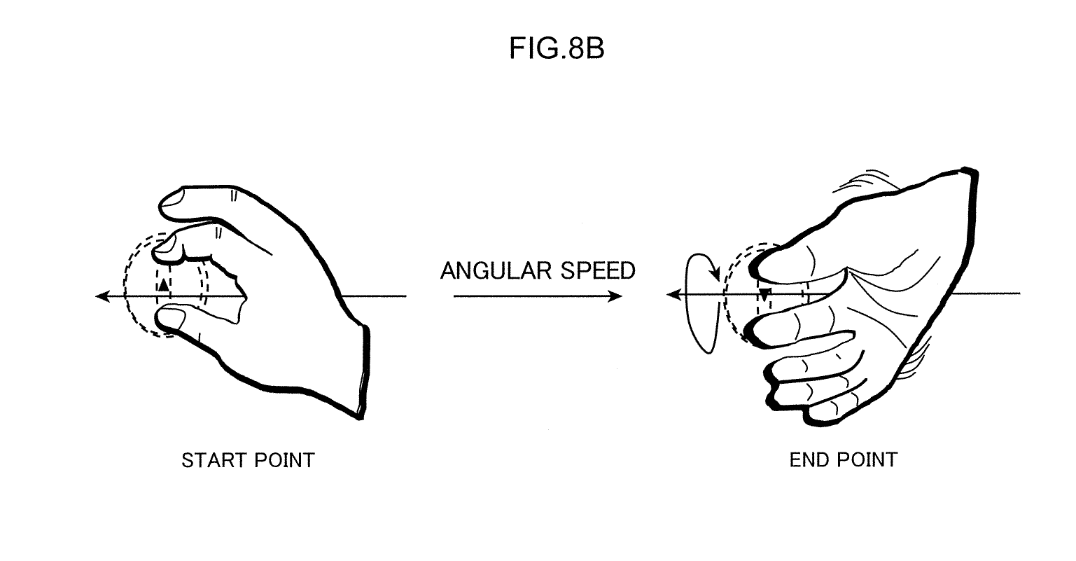

FIG. 8A shows a series of images representing other movement of the hand. The gesture recognition of step S110 is further described with reference to FIGS. 4, 5 and 8A.

If the operator moves the hand so as to draw a whirl trail, the gesture recognition block 311 generates vector data representing a whirl vector as shown by the dotted curve in FIG. 8A.

FIG. 8B shows exemplary movement of the operator's hand turning an imaginary knob. Generation of an operation command and speed data is exemplarily described with reference to FIGS. 4, 7A to 8B.

Geometry drawn by a vector of the vector data depends on the movement of the hand as described with reference to FIGS. 7A to 8A. If the operator moves the hand straight, the vector data represents a straight vector. If the operator whirls the hand, the vector data represents a length of a circular trace. If the operator turns the hand, the vector data represents an angular change. The command determination block 312 generates a first operation command which instructs the operation command executer 411 to execute a first operation (e.g. tuning off a heater used as the operation command executer 411). The command determination block 312 generates a second operation command which instructs the operation command executer 411 to execute a second operation (e.g. adjusting a heating level of a heater used as the operation command executer 411).

The gesture recognition block 311 puts the time information into the vector data as described with reference to FIG. 7B. If the operator moves the hand horizontally as shown in FIG. 7B, the speed acquisition block 313 measures a distance from the start point to the end point (i.e. a vector length from the start point to the end point). The speed acquisition block 313 may use the measured distance and the time information to generate speed data which represents a moving speed (linear speed). If the operator whirls the hand as shown in FIG. 8A, the speed acquisition block 313 measures a total length of the circular trace from the start point to the end point. The speed acquisition block 313 may use the measured total length and the time information to generate speed data. If the operator turns the hand as shown in FIG. 8B, the speed acquisition block 313 measures an angular change from the start point to the end point. The speed acquisition block 313 may use the measured total angular change and the time information to generate speed data which represents an angular speed.

The request command generator 315 uses the speed data to determine whether a feedback operation is required or not. If the speed data represents lower moving speed or angular speed than a threshold, the feedback operation executer 421 executes a feedback operation. Otherwise, the operation command executer 411 executes an operation defined by the operation command.

The speed acquisition block 313 may set a coordinate system such as Cartesian coordinate system, polar coordinate system, cylindrical coordinate system, spherical coordinate system or another preferable coordinate system to acquire speed data. The speed acquisition block 313 may use different coordinate systems in response to operation commands received from the command determination block 312.

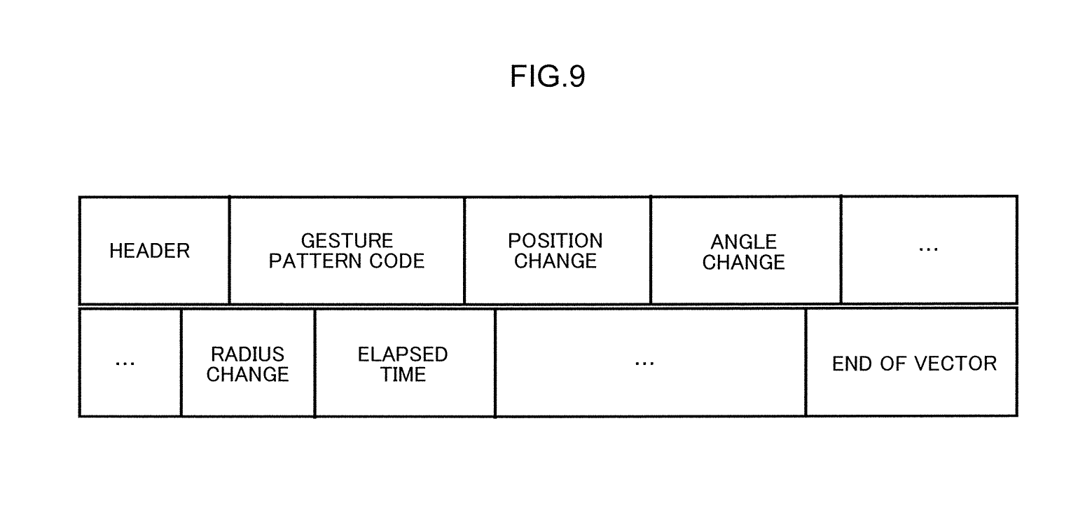

FIG. 9 shows an exemplary data structure of vector data generated by the gesture recognition block 311. The data structure of vector data is described with reference to FIGS. 4 and 9.

The data structure may include a header section, a gesture pattern code section, a position change section, an angle change section, a radius change section, an elapsed time section, a vector end section and other necessary data section. The header section may contain information which is used by the command determination block 312 and the speed acquisition block 313 to read the vector data. The gesture pattern code section may include information to make the command determination block 312 and the speed acquisition block 313 identify a movement pattern of the hand (e.g. straight movement, angular movement or alike). The position change section may include coordination values of the hand at the start and end points. The angle change section may include information of an angular change in a hand position when an operator turns the hand. The radius change section may include information about a radius of a whirl trail of the hand. The elapsed time section may include information about a time length from the start point to the end point. The vector end section may include information used by the command determination block 312 and the speed acquisition block 313 to identify an end of the vector data. The exemplary data structure shown in FIG. 9 may represent various movement patterns of the hand or other body parts. The command determination block 312 may refer one or some of these data sections to determine and generate an operation command. The speed acquisition block 313 may refer one or some of these data sections to determine and generate speed data.

### Fourth Embodiment

An operator may input feedback information to the input device in response to a feedback operation. In the third embodiment, the operator can operate the feedback operation executer to input the feedback information. However, the operator may operate another device to give the feedback information. In the fourth embodiment, the input device allows the operator to input the feedback information by means of another device.

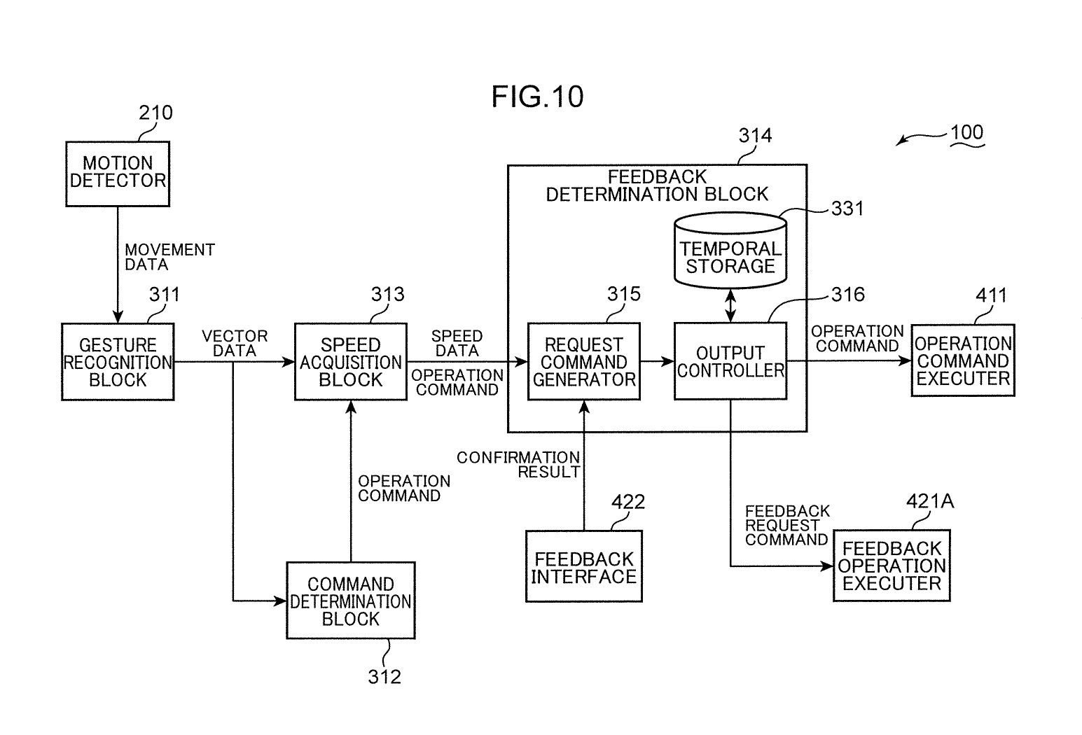

FIG. 10 is another exemplary functional block diagram of the input device 100. The functional block diagram is designed on the basis of the technical concepts described in the context of the first embodiment. Functions of the input device 100 are described in the context of the fourth embodiment with reference to FIGS. 10. It should be noted that the commonly used numerals between FIGS. 4 and 10 mean that elements labeled with the common numerals have the same functions as the third embodiment. Therefore, the description in the third embodiment is applied to these elements.

Like the third embodiment, the input device 100 includes the motion detector 210, the gesture recognition block 311, the command determination block 312, the speed acquisition block 313, the feedback determination block 314 and the operation command executer 411. The input device 100 further includes a feedback operation executer 421 A and a feedback interface 422. Like the third embodiment, the feedback operation executer 421A executes a feedback operation in response to a feedback request command from the feedback determination block 314. On the other hand, the feedback operation executer 421A outputs no confirmation result, unlike the third embodiment. Instead, the feedback interface 422 generates a confirmation result if an operator operates the feedback interface 422. The confirmation result is output from the feedback interface 422 to the request command generator 315. The request command generator 315 then makes the output controller 316 read an operation command from the temporal storage 331 if the operator wants further processes. Eventually, the operation command executer 411 executes a predetermined operation in response to the operation command output from the output controller 316.

For example, the feedback interface 422 may have a sound recognition function to recognize voice of the operator. The feedback interface 422 may output a confirmation result instructing the feedback determination block 314 to proceed or cancel further processes.

### Fifth Embodiment

An operator may input feedback information to the input device in response to a feedback operation. In the fourth embodiment, the operator can operate the dedicated feedback interface to input the feedback information. However, the operator may operate the motion detector to give the feedback information. In the fifth embodiment, the input device allows the operator to input the feedback information by means of the motion detector.

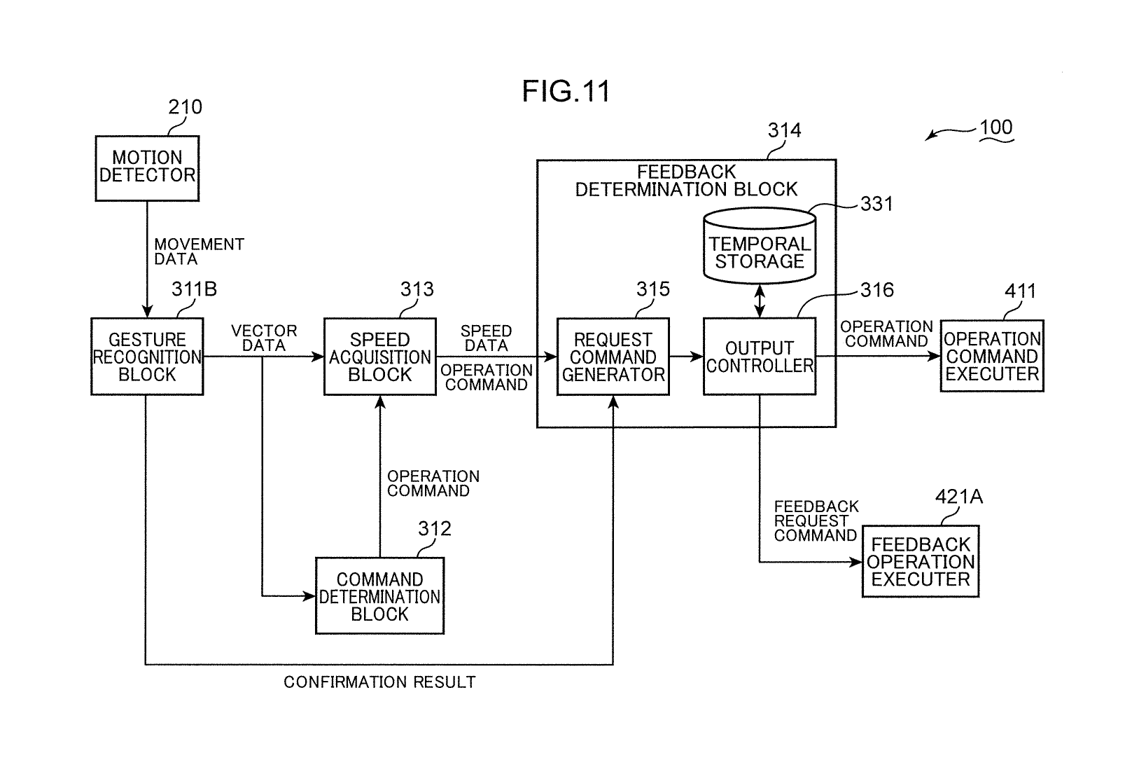

FIG. 11 is another exemplary functional block diagram of the input device 100. The functional block diagram is designed on the basis of the technical concepts described in the context of the first embodiment. Functions of the input device 100 are described in the context of the fifth embodiment with reference to FIGS. 11. It should be noted that the commonly used numerals between FIGS. 10 and 11 mean that elements labeled with the common numerals have the same functions as the fourth embodiment. Therefore, the description in the fourth embodiment is applied to these elements.

Like the fourth embodiment, the input device 100 includes the motion detector 210, the command determination block 312, the speed acquisition block 313, the feedback determination block 314, the operation command executer 411 and the feedback operation executer 421A. The input device 100 further includes a gesture recognition block 311B. The gesture recognition block 311 B has the same function to generate the vector data as the fourth embodiment. In addition, the gesture recognition block 311B has a function to recognize specific gestures in the movement data as data for generating a confirmation result.

If an operator makes a specific gesture to cause a confirmation result, the gesture recognition block 311B generates the confirmation result instructing the feedback determination block 314 to proceed or cancel further processes. The confirmation result is output from the gesture recognition block 311B to the request command generator 315 directly, unlike the vector data. The request command generator 315 then makes the output controller 316 read an operation command from the temporal storage 331 if the operator wants further processes. Eventually, the operation command executer 411 executes a predetermined operation in response to the operation command output from the output controller 316.

### Sixth Embodiment

According to the third embodiment, all operation commands pass the feedback determination block. However, it is not necessary for all operation commands to be subjected to processes of the feedback determination block. Some of operation commands may be executed without feedback operations of the feedback operation executer. In the context of the sixth embodiment, technologies to sort operation commands are described.

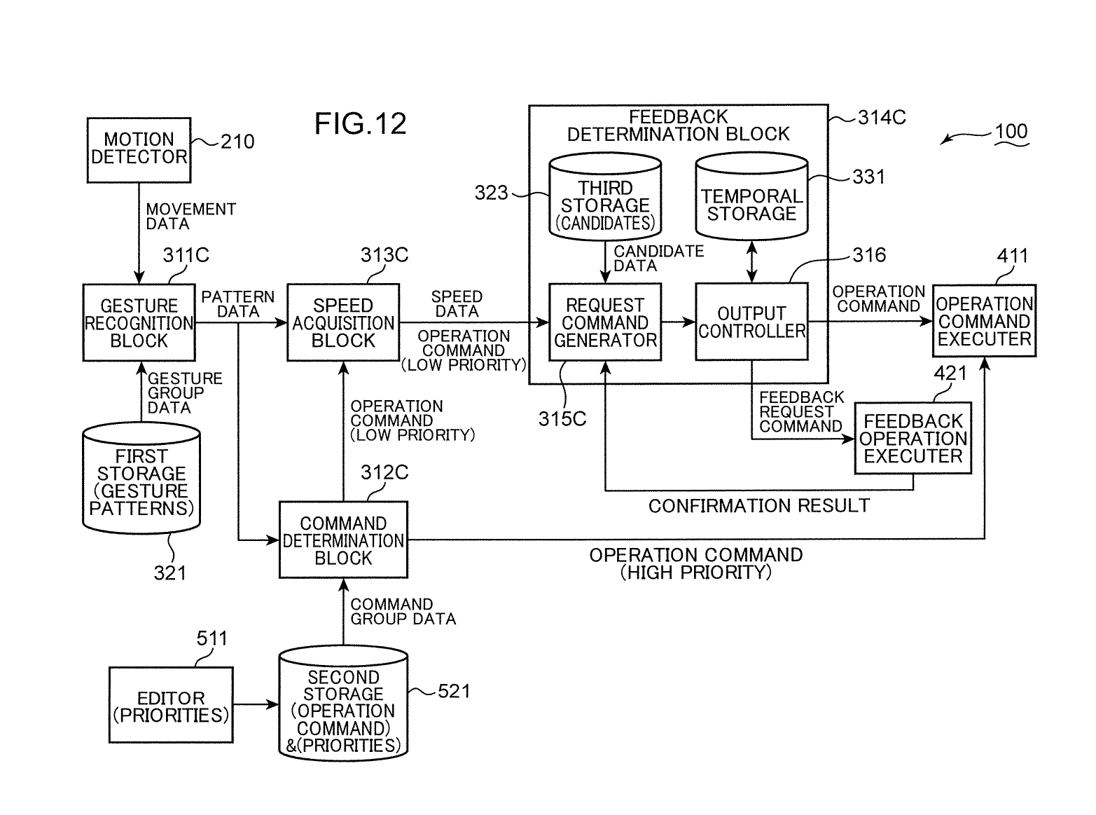

FIG. 12 is an exemplary functional block diagram of the input device 100. The functional block diagram is designed on the basis of the technical concepts described in the context of the first embodiment. Functions of the input device 100 are described in the context of the sixth embodiment with reference to FIGS. 1, 2 and 12. It should be noted that the commonly used numerals between FIGS. 4 and 12 mean that elements labeled with the common numerals have the same functions as the third embodiment. Therefore, the description in the third embodiment is applied to these elements.

Like the third embodiment, the input device 100 includes the motion detector 210, the operation command executer 411 and the feedback operation executer 421. The input device 100 further includes a gesture recognition block 311C, a command determination block 312C, a speed acquisition block 313C, a feedback determination block 314C, a first storage 321, an editor 511 and a second storage 521.

The motion detector 210 generates movement data, like the third embodiment. The movement data is output to the gesture recognition block 311C.

The first storage 321 stores gesture group data about various gesture patterns. Each of the gesture patterns may be a combination of a few gestures. The gesture recognition block 311C reads the gesture group data from the first storage 321. The gesture recognition block 311C then compares the gesture group data with the movement data to identify a part of the gesture group data showing a gesture pattern which is coincident with a gesture pattern represented by the movement data. The gesture recognition block 311C may convert the identified data part into pattern data. The pattern data is output from the gesture recognition block 311C to the command determination block 312C and the speed acquisition block 313C. The first storage 321 may be the ROM 320 or the HDD 340, which is described with reference to FIG. 2.

The second storage 521 stores command group data about several operation commands, and priority data to categorize the operation commands of the command group data into a high or low priority. Each of the operation commands in the command group data may be associated with each of the gesture patterns in the gesture group data.

The command determination block 312C reads the command group data from the second storage 521 once the command determination block 312C receives the pattern data from the gesture recognition block 311C. The command determination block 312C then compares the command group data with the pattern data to identify an operation command which corresponds to a gesture pattern defined by the pattern data. It should be noted that the identified operation command is labeled with one of high and low priorities by the priority data as described above. In this embodiment, if the identified operation command is labeled with low priority, the operation command is executed after determination whether a feedback operation is required or not. Otherwise, the operation command is executed without a feedback operation. The priority data is exemplified as the identifier representing whether the feedback operation is required or not.

The command determination block 312C may refer the priority data attached to the identified operation command to determine an output route of the operation command.

In this embodiment, two routes are prepared for operation commands from the command determination block 312C as shown in FIG. 12. One extends from the command determination block 312C to the speed acquisition block 313C. The other extends from the command determination block 312C to the operation command executer 411 directly. Operation commands labeled with the low priority are output from the command determination block 312C to the speed acquisition block 313C, and subjected to various processes of the speed acquisition block 313C and the feedback determination block 314C. Eventually, the operation commands labeled with the low priority are executed by the operation command executer 411. Operation commands labeled with the high priority are output from the command determination block 312C to the operation command executer 411 directly without passing through the speed acquisition block 313C and the feedback determination block 314C. Once the operation command executer 411 receives the operation commands labeled with the high priority, the operation command executer 411 executes the operation commands labeled with the high priority without waiting for a feedback operation.

An operator may use the editor 511 to edit the priority data. If the operator often makes a specific gesture, the operator may not need a feedback operation. In this case, the operator uses the editor 511 to put a label of “high priority” to an operation command corresponding to the specific gesture. Alternatively, the editor 511 may automatically update the priority data on the basis of usage frequency of operation commands. In this embodiment, the second storage 521 corresponds to the portable recording medium 520 described with reference to FIG. 2. The editor 511 corresponds to the editing device 510 described with reference to FIG. 2.

The pattern data is output from the gesture recognition block 311C to not only the command determination block 312C but also the speed acquisition block 313C, as described above. Each of the gesture patterns represented by the gesture group data may include a start gesture to define a start point and an end gesture to define an end point. An operator may make a specific gesture as the start gesture when the operator starts inputting an operational request. Likewise, the operator may make another specific gesture as the end gesture when the operator ends inputting the operational request. The pattern data may include time data representing a time length from the start point defined by the start gesture to the end point defined by the end gesture. The speed acquisition block 313C may use the time data of the pattern data as the speed data. The speed data is output from the speed acquisition block 313C to the feedback determination block 314C. The operation command labeled with the low priority is also output form the speed acquisition block 313C to the feedback determination block 314C.

Like the third embodiment, the feedback determination block 314C includes the output controller 316 and the temporal storage 331. The feedback determination block 314C further includes a request command generator 315C and a third storage 323. The request command generator 315C receives the speed data and the operation command labeled with the low priority. The third storage 323 stores candidate data representing various feedback operations. Each of the feedback operations represented by the candidate data may be associated with each of operation commands labeled with the low priority. In this embodiment, the third storage 323 is exemplified as the feedback candidate storage.

The request command generator 315C reads the candidate data from the third storage 323. The request command generator 315C compares an operation command received from the speed acquisition block 313C with the candidate data. If one of the feedback operations represented by the candidate data corresponds to the operation command, the request command generator 315C verifies whether the speed data shows a lower speed than a threshold. If the speed data shows a lower speed than the threshold, the request command generator 315C generates a feedback request command representing the corresponding feedback operation, like the third embodiment. The feedback request command is output to the feedback operation executer 421 through the output controller 316. The feedback operation executer 421 executes a feedback operation defined by the feedback request command. After the operator confirms the feedback operation showing that the operational request is appropriately input to the input device 100, the request command generator 315C makes the operation command to be output to the operation command executer 411 through the output controller 316. The operation command executer 411 executes an operation defined by the operation command. In this embodiment, the request command generator 315C is exemplified as the feedback determination portion.

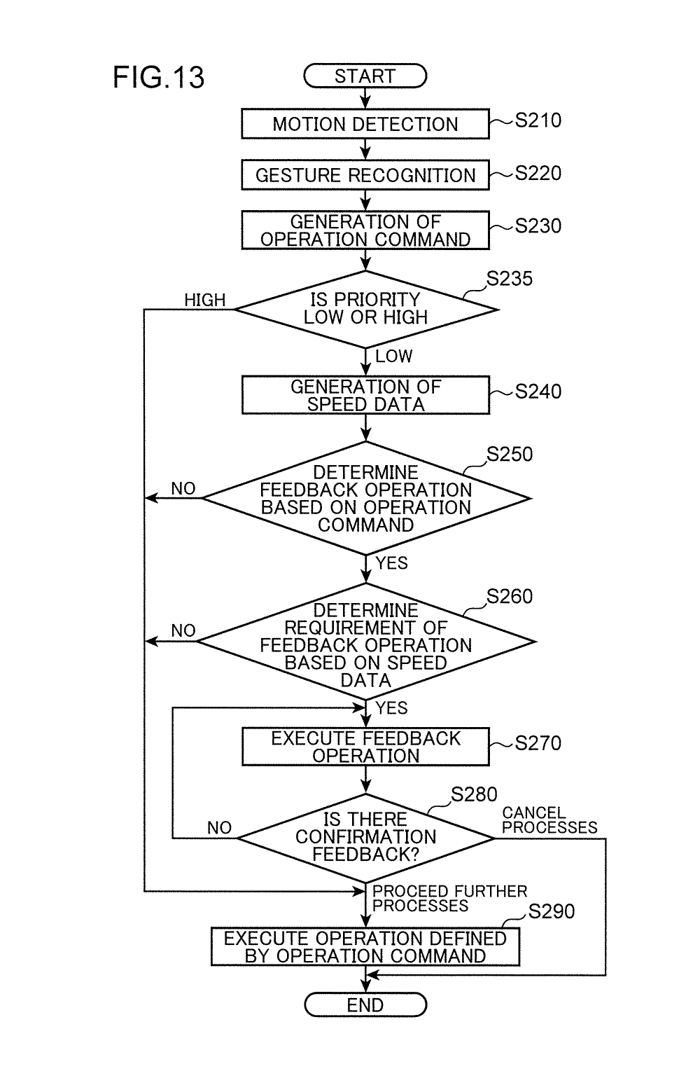

FIG. 13 is a schematic flowchart of processes of the input device 100. The flowchart is designed on the basis of the configuration described with reference to FIG. 12. The processes of the input device 100 are described with reference to FIGS. 12 and 13. It should be noted that the flowchart in FIG. 13 is just exemplary. Therefore, the input device 100 may execute various subsidiary processes in addition to the steps in FIG. 13.

### (Step S210)

In step S210, the motion detector 210 detects movement of a body part of an operator. The motion detector 210 then generates image data as movement data representing the motion of the operator. The image data is output from the motion detector 210 to the gesture recognition block 311C. After that, step S220 is executed.

### (Step S220)

In step S220, the gesture recognition block 311C reads gesture group data from the first storage 321. The gesture recognition block 311C compares the gesture group data with the image data to identify a gesture pattern corresponding to the gestures represented by the image data. The gesture recognition block 311C generates pattern data which represents the corresponding gesture pattern. The pattern data is sent from the gesture recognition block 311C to the command determination block 312C and the speed acquisition block 313C. After that, step S230 is executed.

### (Step S230)

In step S230, the command determination block 312C reads command group data from the second storage 521. The command determination block 312C compares the command group data with the pattern data to identify an operation command corresponding to the gesture pattern represented by the pattern data. The command determination block 312C generates the corresponding operation command. After that, step S235 is executed.

### (Step S235)

In step S235, the command determination block 312C refers priority data attached to the operation command. If the priority data shows a low priority, the operation command is output from the command determination block 312C to the speed acquisition block 313C. Otherwise, the operation command is output from the command determination block 312C to the operation command executer 411. If the operation command is output to the speed acquisition block 313C, step S240 is executed. If the operation command is output to the operation command executer 411, step S290 is executed.

### (Step S240)

In step S240, the speed acquisition block 313C refers time data included in the pattern data. The time data shows a time length defined by the start and end gestures as described above. The speed acquisition block 313C uses the time data to generate the speed data. The speed data is output from the speed acquisition block 313C to the request command generator 315C. Meanwhile, the operation command labeled with the low priority is also output from the speed acquisition block 313C to the request command generator 315C. After that, step S250 is executed.

### (Step S250)

In step S250, the request command generator 315C reads candidate data from the third storage 323. The request command generator 315C compares the candidate data with the operation command labeled with the low priority to identify a feedback operation which corresponds to the operation command. If one of the feedback operations represented by the candidate data is associated with the received operation command, step S260 is executed. If none of the feedback operations represented by the candidate data is associated with the received operation command, step S290 is executed.

### (Step S260)

In step S260, the request command generator 315C compares a speed represented by the speed data with a threshold. If the speed is lower than the threshold, the request command generator 315C determines that a feedback operation is required. The request command generator 315C then generates a feedback request command which is used for instructing the feedback operation executer 421 to execute the feedback operation determined in step S250. The feedback request command is output from the request command generator 315C to the feedback operation executer 421 through the output controller 316. The operation command is output from the request command generator 315C to the temporal storage 331 through the output controller 316. After that, step S270 is executed. Unless the speed is lower than the threshold, the request command generator 315C determines that no feedback operation is required. The request command generator 315C outputs the operation command to the operation command executer 411 through the output controller 316. After that, step S290 is executed.

### (Step S270)

In step S270, the feedback operation executer 421 executes the feedback operation in response to the feedback request command. Accordingly, the operator may confirm whether the input device 100 receives an operational request from the operator appropriately. After that, step S280 is executed.

### (Step S280)

In step S280, the request command generator 315C waits for a feedback input from the operator. If the operator operates the feedback operation executer 421 to request further processes, step S290 is executed. If the operator operates the feedback operation executer 421 to cancel processes, the input device 100 stops processes.

### (Step S290)

In step S290, the operation command executer 411 executes a predetermined operation in response to the operation command.

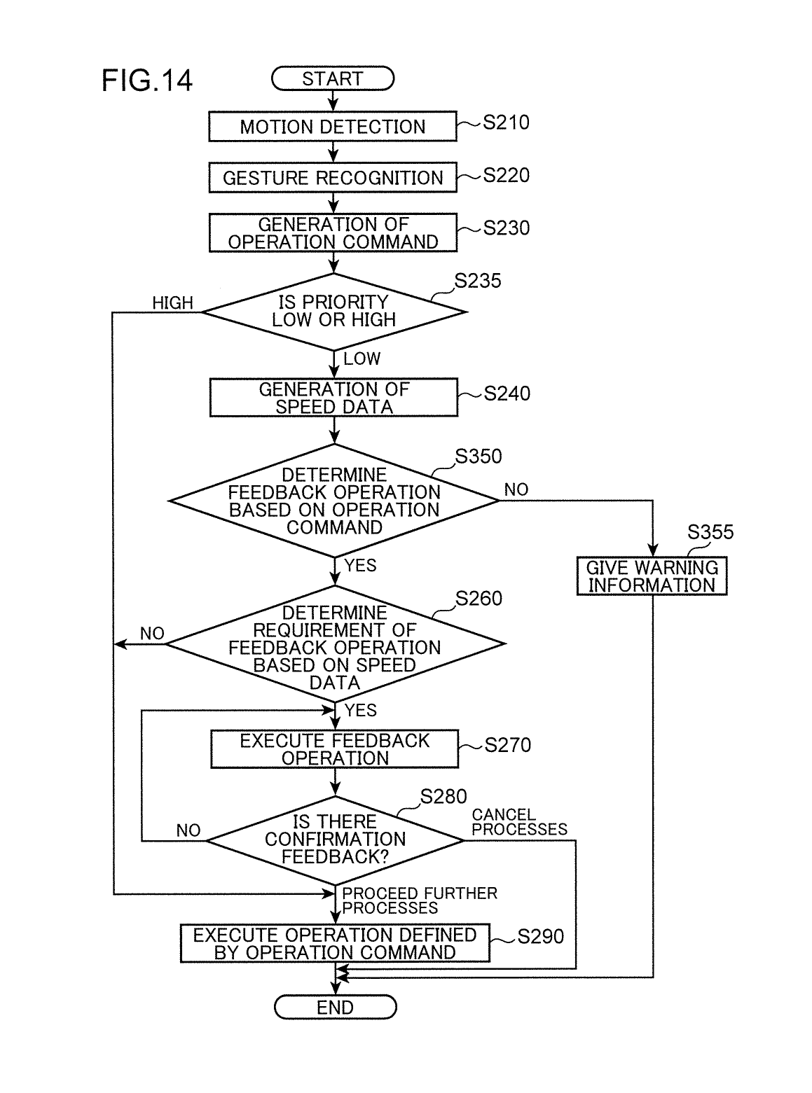

FIG. 14 is another schematic flowchart of processes of the input device 100. The flowchart is also designed on the basis of the configuration described with reference to FIG. 12. The processes of the input device 100 are described with reference to FIGS. 12 to 14. It should be noted that the flowchart in FIG. 14 is just exemplary. Therefore, the input device 100 may execute various subsidiary processes in addition to the steps in FIG. 14.

The process sequence from step S210 to step S240 is the same as that described with reference to FIG. 13. The input device 100 executes step S350 instead of step S250.

### (Step S350)

In step S350, if one of the feedback operations represented by the candidate data is associated with the operation command, the process sequence from step S260 to step S290 is executed, like the flowchart shown in FIG. 13. If none of the feedback operations represented by the candidate data is associated with the operation command, the request command generator 315C generates a feedback request command which instructs the feedback operation executer 421 to give an operator warning information. The feedback request command about the warning information is output to the feedback operation executer 421 through the output controller 316. After that, step S355 is executed.

### (Step S355)

In step S355, the feedback operation executer 421 gives the warning information, and then the input device 100 stops processes. The operator may retry inputting an operational request to the input device 100. The input device 100 then restarts step S210.

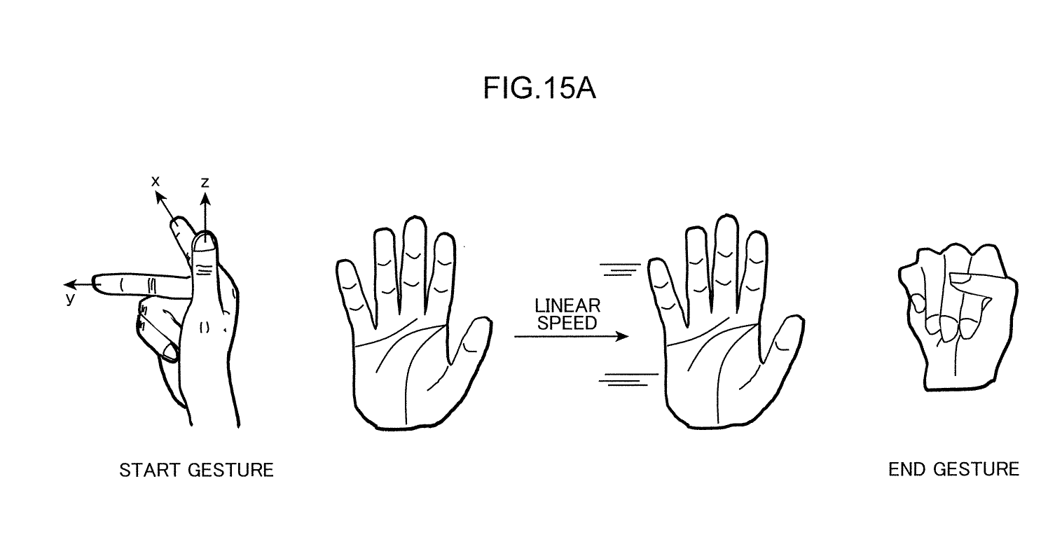

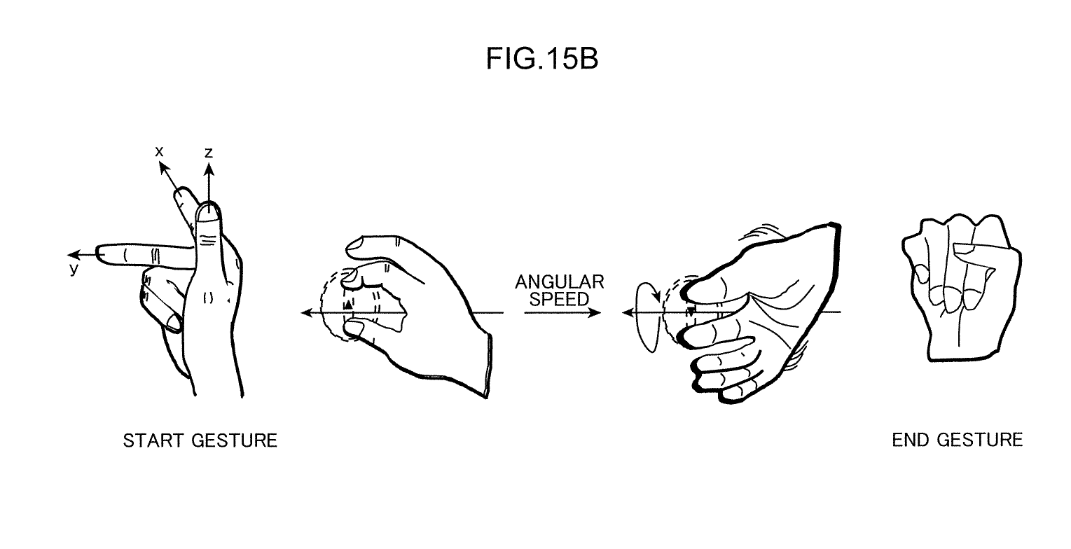

FIG. 15A shows an exemplary gesture pattern. FIG. 15B shows another exemplary gesture pattern. The gesture patterns are described with reference to FIGS. 6, 12, 15A and 15B.

An operator may define a three dimensional coordination system by hand at first. In FIGS. 15A and 15B, the operator stretches the index finger, the middle finger and the thumb straight in different directions from each other to define the three-dimensional coordination system. The index finger defines x-axis. The middle finger defines y-axis. The thumb defines z-axis. In this embodiment, one of x, y, z-axes is exemplified as the first axis. Another of these coordination axes is exemplified as the second axes. The remaining coordination axis is exemplified as the third axis.

Like the image recognition technologies described with reference to FIG. 6, the gesture recognition block 311C extracts data representing the hand of the operator. When the hand defines the three-dimensional coordination system, the gesture recognition block 311C recognizes the gesture of the hand defining the three-dimensional coordination system as the start gesture.

The operator may close the hand at the end of the gesture pattern. The gesture recognition block 311C recognizes the gesture of the closed hand as the end gesture.

The operator may make various gestures between the start and end gestures. In FIG. 15A, the operator moves the hand along y-axis defined by the middle finger. In FIG. 15B, the operator circularly moves the thumb and the index finger around the y-axis defined by the middle finger. The gesture recognition block 311C may identify what an operational request the operator input, by comparing a gesture between the start and end gestures with the gesture group data.

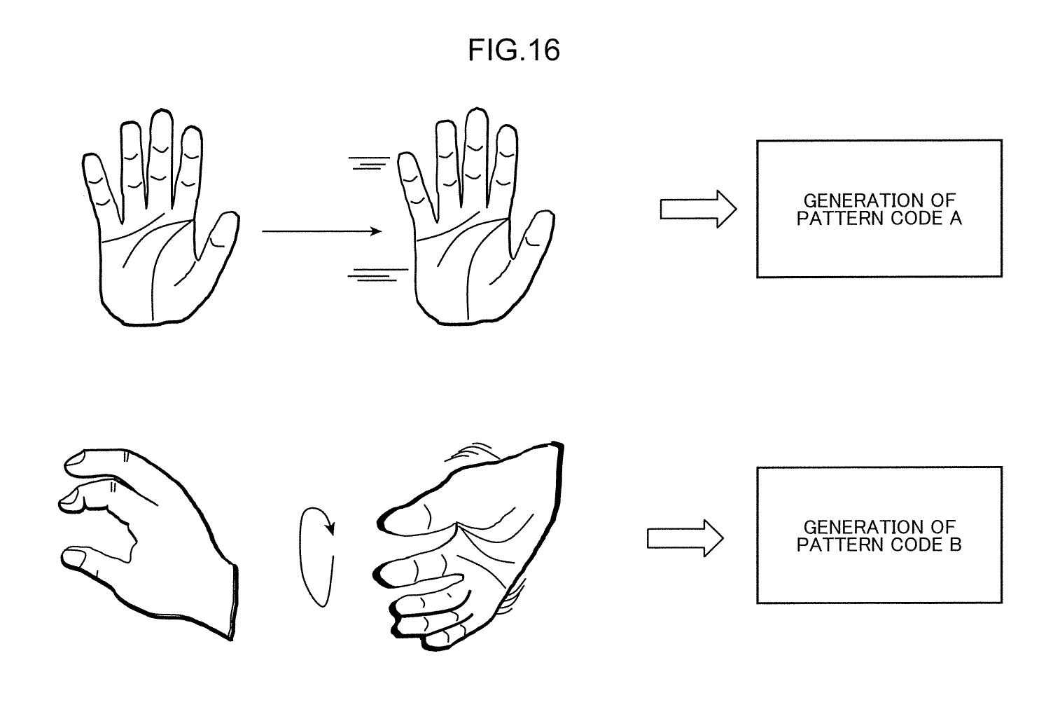

FIG. 16 is a conceptual view of generation of pattern data. The generation of the pattern data is described with reference to FIGS. 12, 15A to 16.

If the gesture recognition block 311C identifies the hand gesture shown in FIG. 15A between the start and end gestures, the gesture recognition block 311C incorporates “pattern code A” into the pattern data. If the gesture recognition block 311C identifies the hand gesture shown in FIG. 15B between the start and end gestures, the gesture recognition block 311C incorporates “pattern code B” into the pattern data. It should be noted that the pattern code B is different from the pattern code A. As described above, the pattern data is output to the command determination block 312C.

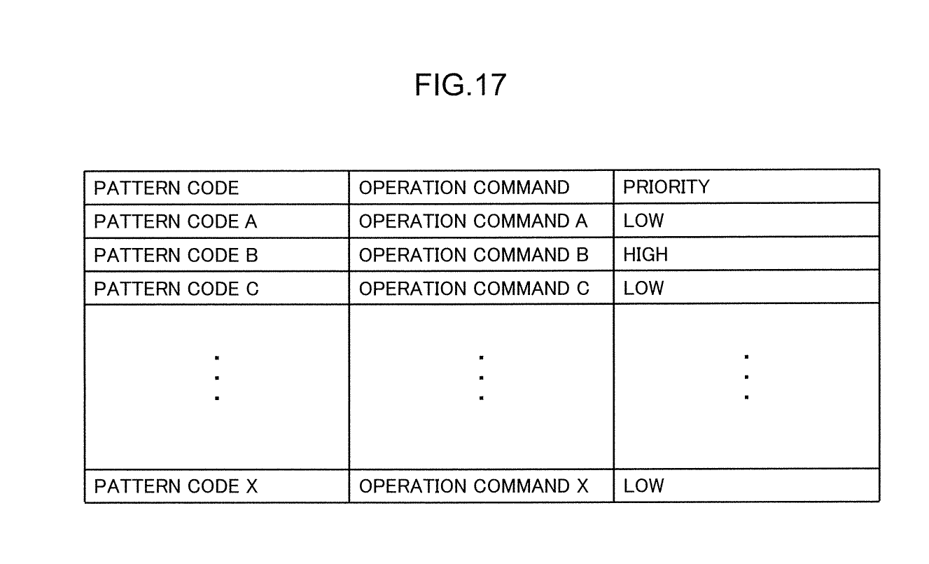

FIG. 17 is a conceptual view of data structure of the command group data stored in the second storage 521. The data structure of the command group data is described with reference to FIGS. 12, 16 and 17.

The command group data includes data about various pattern codes which the gesture recognition block 311C may incorporate in the pattern data. The command group data further includes data about various operation commands. The command group data associates each of the operation commands with each of the pattern codes as shown in FIG. 17. The command determination block 312C reads the command group data from the second storage 521. The command determination block 312C may refer the column of “pattern code” in FIG. 17 to identify a corresponding operation command to the pattern data. If the pattern data includes the pattern code A, the command determination block 312C chooses and generates the operation command A. If the pattern data includes the pattern code B, the command determination block 312C chooses and generates the operation command B. If the pattern data includes the pattern code C, the command determination block 312C chooses and generates the operation command C. It should be noted the operation defined by each of the operation commands A, B, C is different from each other. In this embodiment, the operation defined by the operation command A is exemplified as the first operation. The operation defined by the operation command C is exemplified as the second operation.

The command group data further includes priority data. The command group data associates each of the operation commands with the high or low priority. In FIG. 17, the operation command A is labeled with the low priority. The operation command B is labeled with the high priority. The operation command C is labeled with the low priority.

The command determination block 312C refers the priority data attached to the selected operation command. If the command determination block 312C selects the operation command A or C, the command determination block 312C finds the label of the low priority. If the command determination block 312C selects the operation command B, the command determination block 312C finds the label of the high priority.

The command determination block 312C determines an output route of the operation command on the basis of the priority data. If the command determination block 312C selects the operation command A or C, the command determination block 312C outputs the operation command A or C to the speed acquisition block 313C due to the label of the low priority. lithe command determination block 312C selects the operation command B, the command determination block 312C outputs the operation command B to the operation command executer 411 due to the label of the high priority.

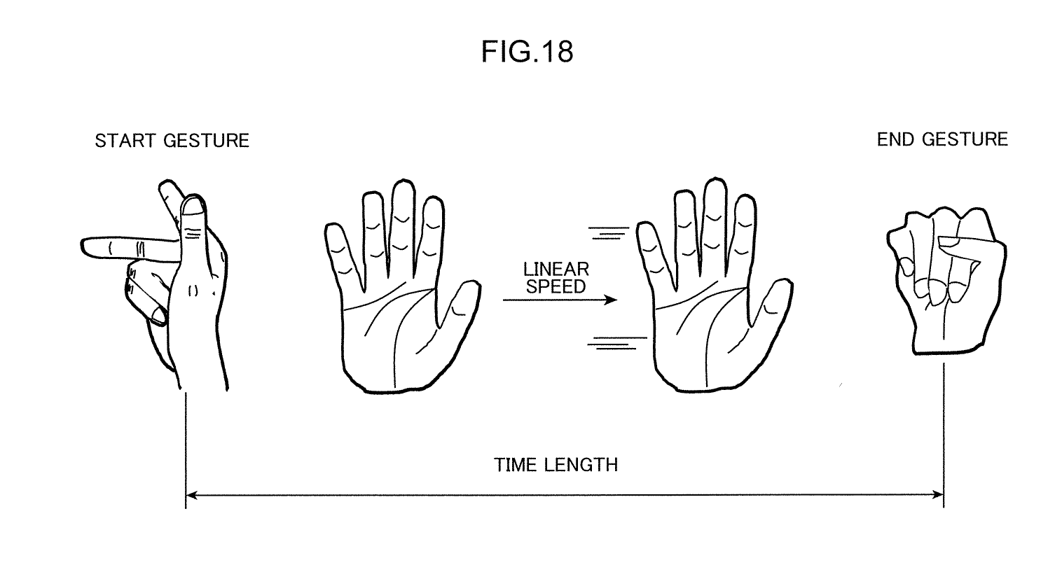

FIG. 18 is a conceptual view of the time data incorporated into the pattern data. The time data is described with reference to FIGS. 12, 17 and 18.

The gesture recognition block 311 C incorporates data about a time length from the start gesture to the end gesture into the pattern data. The speed acquisition block 313C extracts the data about the time length. The extracted data is output from the speed acquisition block 313C to the request command generator 315C with the operation command labeled with low priority (operation command A or C).

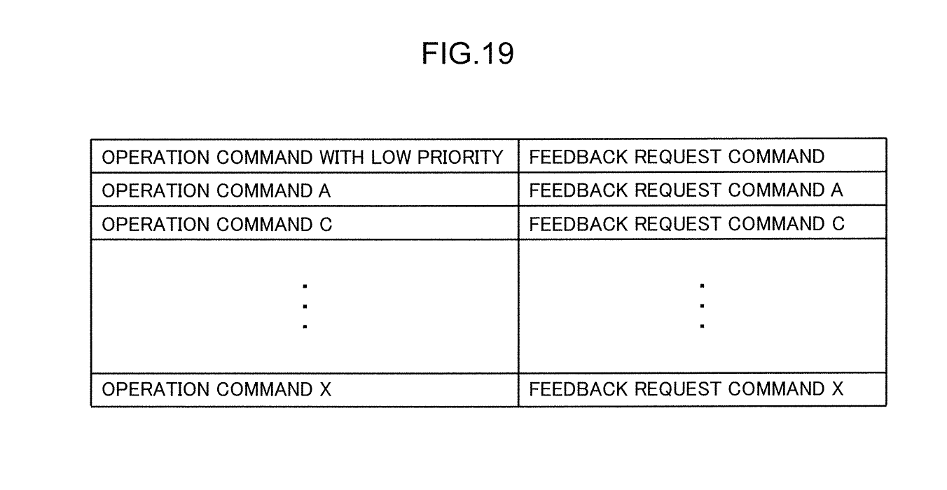

FIG. 19 is a conceptual view of a data structure of the candidate data stored in the third storage 323. The data structure of the candidate data is described with reference to FIGS. 12 and 19.

The candidate data includes data about various operation commands labeled with the low priority. The candidate data further includes data about various feedback request commands. Feedback operations defined by the feedback request commands listed in the candidate data may be different from each other. The candidate data associates each of the operation commands with each of the feedback request commands. If the request command generator 315C receives the operation command A, the request command generator 315C generates the feedback request command A when the time data shows a lower speed than a threshold. If the request command generator 315C receives the operation command C, the request command generator 315C generates the feedback request command C when the time data shows a lower speed than the threshold. In this embodiment, the feedback operation defined by the feedback request command A is exemplified as the first feedback operation. The feedback operation defined by the feedback request command C is exemplified as the second feedback operation.

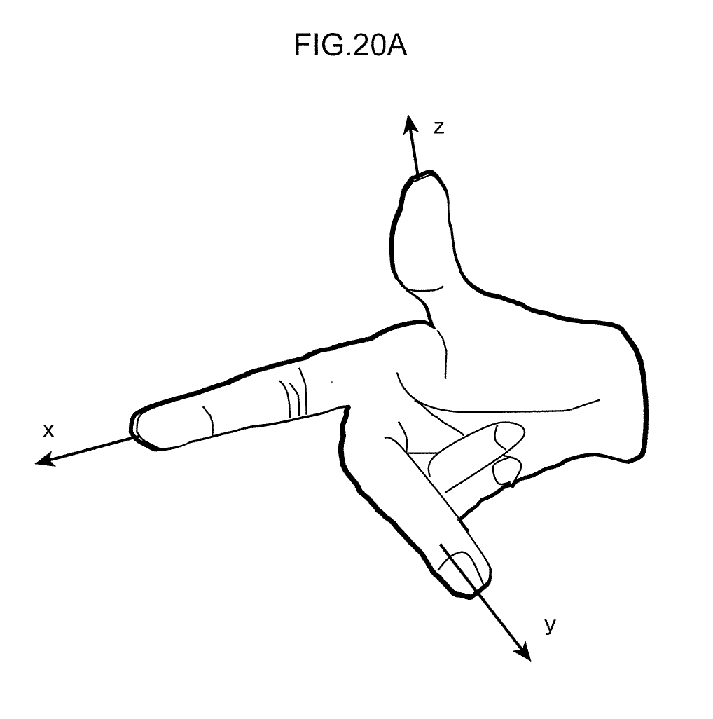

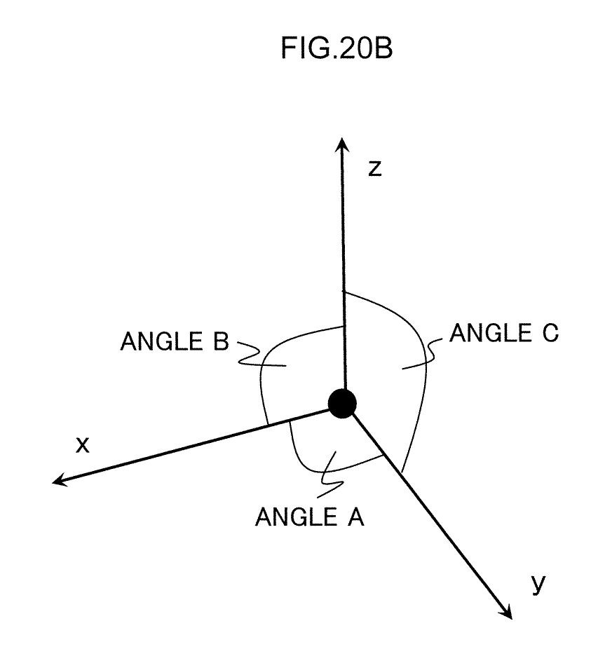

FIG. 20A is a schematic perspective view of a hand gesture making the start gesture. FIG. 20B shows a three-dimensional coordination system. The start gesture is described with reference to FIGS. 12, 20A and 20B.

An operator may stretch the index finger, the middle finger and the thumb straight in different directions from each other to make the start gesture as shown FIG. 20A. The index finger defines a direction of x-axis. The middle finger defines a direction of y-axis. The thumb defines a direction of z-axis. A three-dimensional coordination system may be defined by these fingers as shown in FIG. 20B.

FIG. 20B shows an angle A defined between x-axis and y-axis, an angle B defined between x-axis and z-axis and an angle C defined between y-axis and z-axis. These angles A, B, C are ranged from 70 to 120 degrees, respectively. The operator may be less likely to unintentionally make these angles. Therefore, if the gesture recognition block 311C recognizes the hand gesture shown in FIG. 20A, operational errors are less likely to happen to the operation command executer 411.

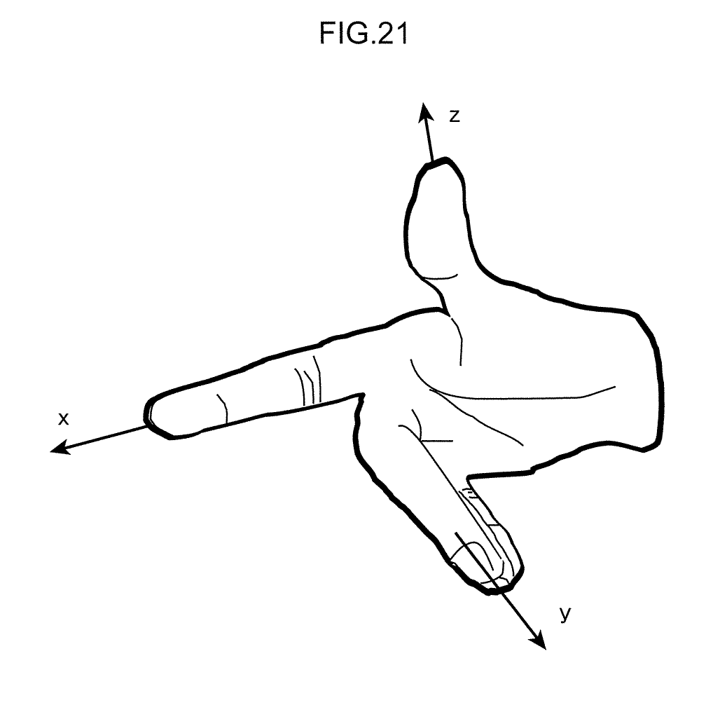

FIG. 21 is a schematic perspective view of anther hand gesture making the start gesture. The start gesture is described with reference to FIGS. 12, 20A to 21.

Unlike the hand gesture described with reference to FIG. 20A, an operator stretches not only the middle finger but also the ring finger and the little finger to define z-axis. The gesture recognition block 311C may recognize the three-dimensional coordination system of FIG. 20B from the hand gesture shown in FIG. 21.

### Seventh Embodiment

According to the third to sixth embodiments, the input device outputs an operation command in response to a confirmation result if there is requirement of a feedback operation. However, if there is a delay time long enough for an operator to confirm a feedback operation and make necessary actions, the confirmation result may not be required. In the seventh embodiment, an exemplary delay function is described.

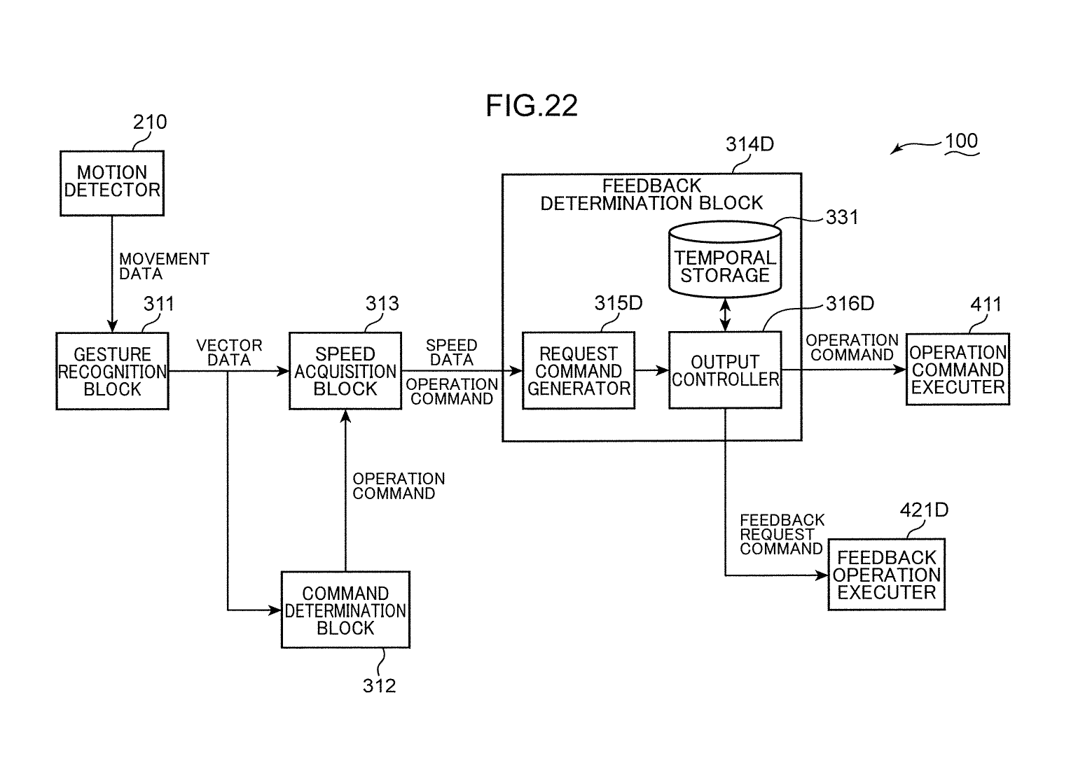

FIG. 22 is an exemplary functional block diagram of the input device 100. The functional block diagram is designed and simplified on the basis of the technical concepts described in the context of the third embodiment. The input device 100 is described with reference to FIG. 22. It should be noted that the commonly used numerals between FIGS. 4 and 22 mean that elements labeled with the common numerals have the same functions as the third embodiment. Therefore, the description in the third embodiment is applied to these elements.

Like the third embodiment, the input device 100 includes the motion detector 210, the command determination block 312, the speed acquisition block 313 and the operation command executer 411. The input device 100 further includes a feedback determination block 314D and a feedback operation executer 421D.

Like the third embodiment, the feedback determination block 314D includes the temporal storage 331. The feedback determination block 314D further includes a request command generator 315D and an output controller 316D.

Like the third embodiment, the request command generator 315D receives the speed data and the operation command. The request command generator 315D outputs not only the operation command but also a feedback request command to the output controller 316D if the speed data represents a lower speed than a threshold. Otherwise, the request command generator 315D outputs only the operation command to the output controller 316D. Unlike the third embodiment, the request command generator 315D receives no confirmation result.

If the output controller 316D receives both of the operation command and the feedback request command, the output controller 316D outputs the operation command to the temporal storage 331 and the feedback request command to the feedback operation executer 421D. If the output controller 316D receives only the operation command, the output controller 316D outputs the operation command to the operation command executer 411. Unlike the third embodiment, the output controller 316D has a delay function.

Once the feedback operation executer 421D receives the feedback request command, the feedback operation executer 421D executes a feedback operation defined by the received feedback request command. Unlike the third embodiment, the feedback operation executer 421D outputs no confirmation result after the feedback operation.

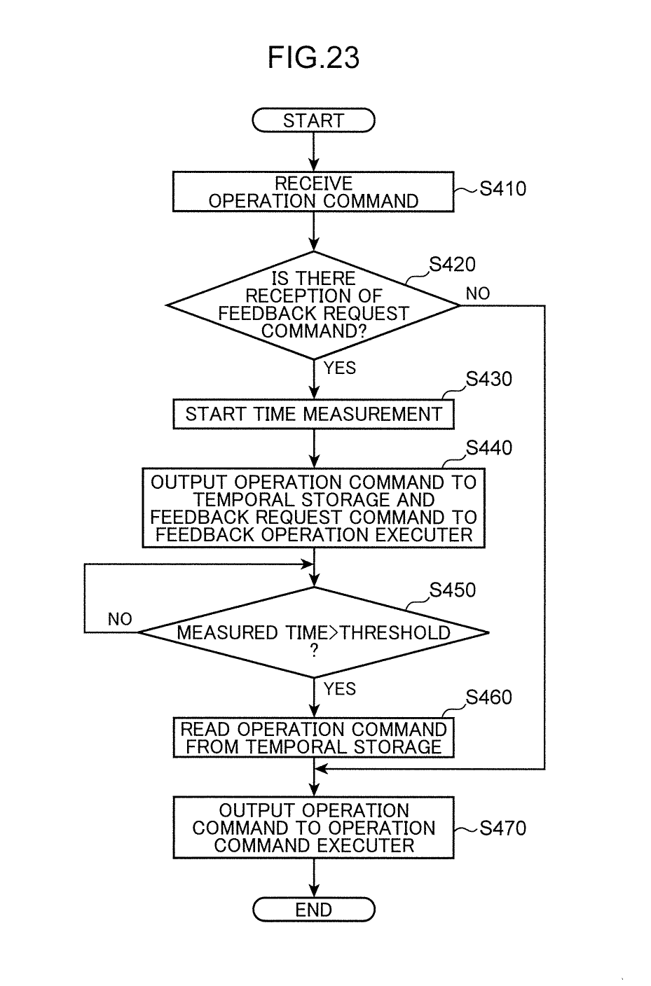

FIG. 23 is a schematic flowchart of processes of the output controller 316D described with reference to FIG. 22. The processes of the output controller 316D are described with reference to FIGS. 22 and 23. It should be noted that the flowchart in FIG. 23 is just exemplary. Therefore, the output controller 316D may execute various subsidiary processes in addition to the steps in FIG. 23.

### (Step S410)

In step S410, the output controller 316D receives an operation command from the request command generator 315D. Step S420 is then executed.

### (Step S420)

In step S420, the output controller 316D determines whether the output controller 316D receives a feedback request command from the request command generator 315D. If the output controller 316D receives the feedback request command, step S430 is executed. Otherwise, step S470 is executed.

### (Step S430)

In step S430, the output controller 316D starts measuring a time. Step S440 is then executed.

### (Step S440)

In step S440, the output controller 316D outputs the operation command to the temporal storage 331 and the feedback request command to the feedback operation executer 421D. Step S450 is then executed.

### (Step S450)

In step S450, the output controller 316D compares a time length of the measured time from step S430 with a threshold until the time length exceeds the threshold. The threshold for the time length is set so that an operator can confirm a feedback operation of the feedback operation executer 421D and take necessary actions such as cancellation of the operational request or other actions. After the time length exceeds the threshold, step S460 is executed.

### (Step S460)

In step S460, the output controller 316D reads the operation command from the temporal storage 331. Step S470 is then executed.

### (Step S470)

The output controller 316D outputs the operation command to the operation command executer 411.

### Eighth Embodiment

The various technologies described in the context of the first to the seventh embodiments may be incorporated into various apparatuses configured to operate under operational requests from an operator. In the context of the eighth embodiment, an IH cooking heater is described as such apparatuses.

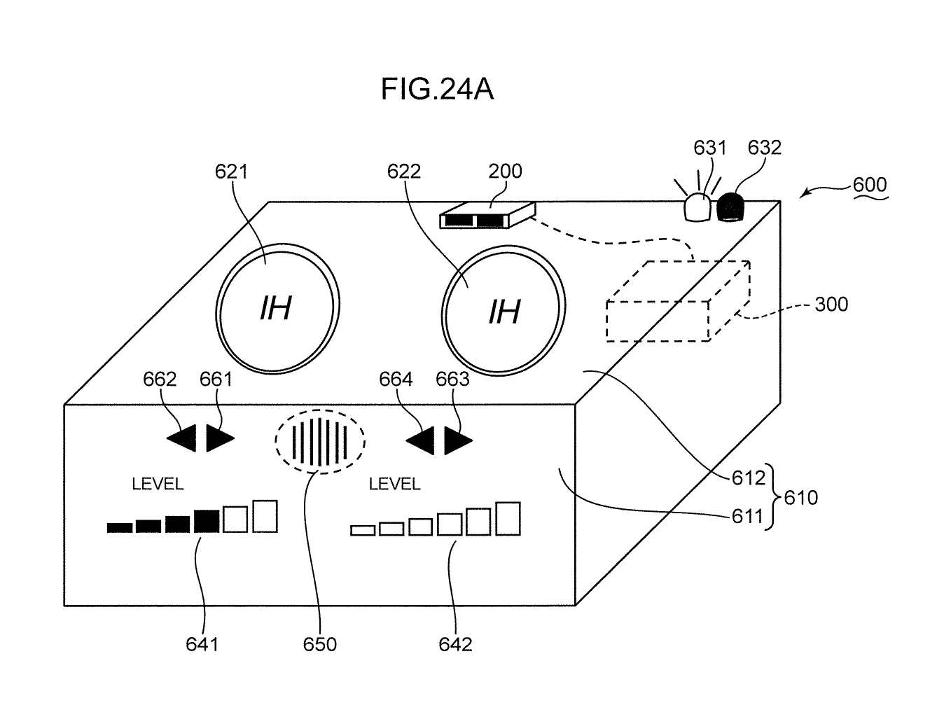

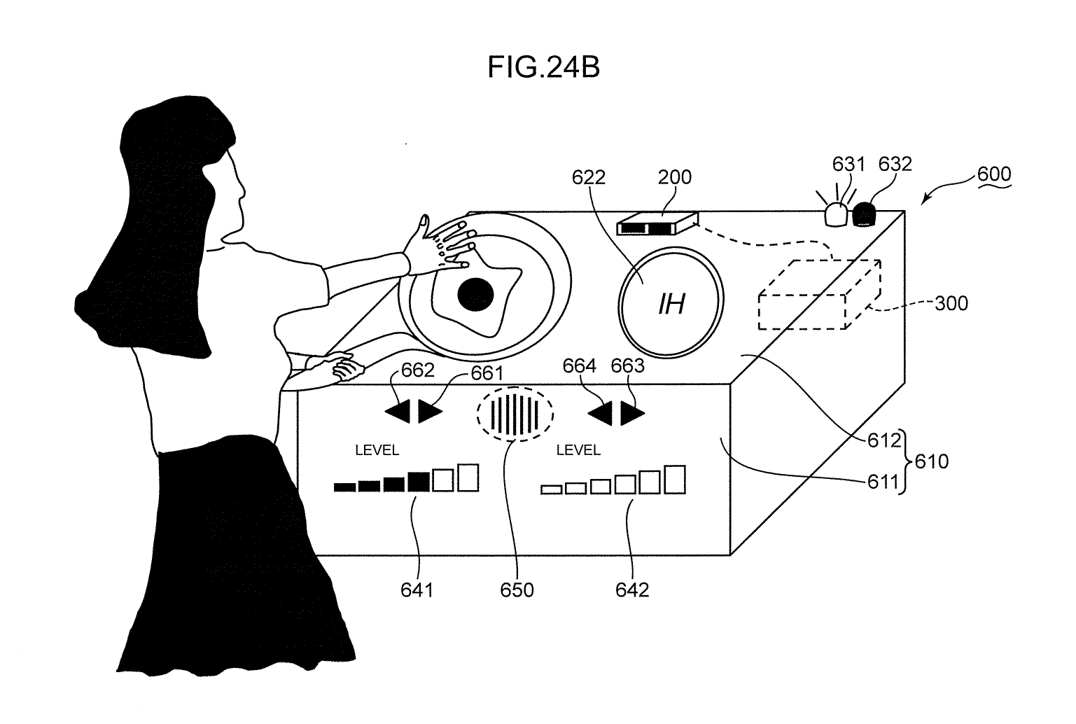

FIG. 24A is a schematic perspective view of the cooking heater 600. FIG. 24B shows an operator using the cooking heater 600 to heat an egg. The cooking heater 600 is described with reference to FIGS. 1, 24A and 24B.

The cooking heater 600 includes a rectangular housing 610. The rectangular housing 610 includes a front wall 611 and a top wall 612. A left heating area 621 and a right heating area 622 are formed on the top wall 612. The operator uses the left heating area 621 to heat the egg. The operator uses the left hand to hold a frying pan. The operator may use the right hand to make various gestures.

The sensor 200 described with reference to FIG. 1 is mounted on the top wall 612. The sensor 200 is wired to the processing unit 300 described with reference to FIG. 1. The processing unit 300 is stored in the housing 610. The operator may make various hand gestures in front of the sensor 200.

The cooking heater 600 further includes a left emitter 631 and a right emitter 632. The left and right emitters 631, 632 are mounted on the top wall 612. The left emitter 631 corresponds to one of the operating devices 400 described with reference to FIG. 1. The right emitter 632 corresponds to another of the operating devices 400 described with reference to FIG. 1.

The left emitter 631 may emit light when the left heating area 621 is heated. The right emitter 632 may emit light when the right heating area 622 is heated. The left and right emitters 631, 632 may change an emission pattern in response to a gesture made by the operator as the feedback operation under control of the processing unit 300. The operator may watch the emission pattern to confirm whether an operational request is appropriately input to the cooking heater 600 or not.

The cooking heater 600 further includes a left indicator 641 and a right indicator 642 on the front wall 611. The left indicator 641 indicates a heating level of the left heating area 621. The right indicator 642 indicates a heating level of the right heating area 622. Each of the left and right indicators 641, 642 includes several indication windows from which light is emitted. In FIGS. 24A and 24B, the black indication windows emit light. The white indication windows emit no light. A number of the black indication windows represent a heating level.

The left and right indicators 641, 642 may change a number of indication windows emitting light in response to a hand gesture made by the operator under control of the processing unit 300 before the left and right heating areas 621, 622 are actually heated, respectively. In this case, the operator may watch the left and right indicators 641, 642 to confirm an adjustment volume by the hand gesture. The left indicator 641 corresponds to one of the operating devices 400 described with reference to FIG. 1. The right indicator 642 corresponds to another of the operating devices 400 described with reference to FIG. 1.

The cooking heater 600 further includes a speaker 650 configured to operate under control of the processing unit 300. If the operator makes a hand gesture to increase a heating level, voice “increase in heating level” may sound from the speaker 650. If the operator makes a hand gesture to decrease a heating level, voice “decrease in heating level” may sound from the speaker 650. The operator may listen to voice from the speaker 650 to confirm whether an operational request is appropriately input to the cooking heater 600. The speaker 650 corresponds to one of the operating devices 400 described with reference to FIG. 1.

The cooking heater 600 further includes a left increase button 661, a left decrease button 662, a right increase button 663 and a right decrease button 664 on the front wall 611. The operator may press the left increase button 661 to increase a heating level in the left heating area 621. The operator may press the left decrease button 662 to decrease a heating level in the left heating area 621. The operator may press the right increase button 663 to increase a heating level in the right heating area 622. The operator may press the right decrease button 664 to decrease a heating level in the right heating area 622.

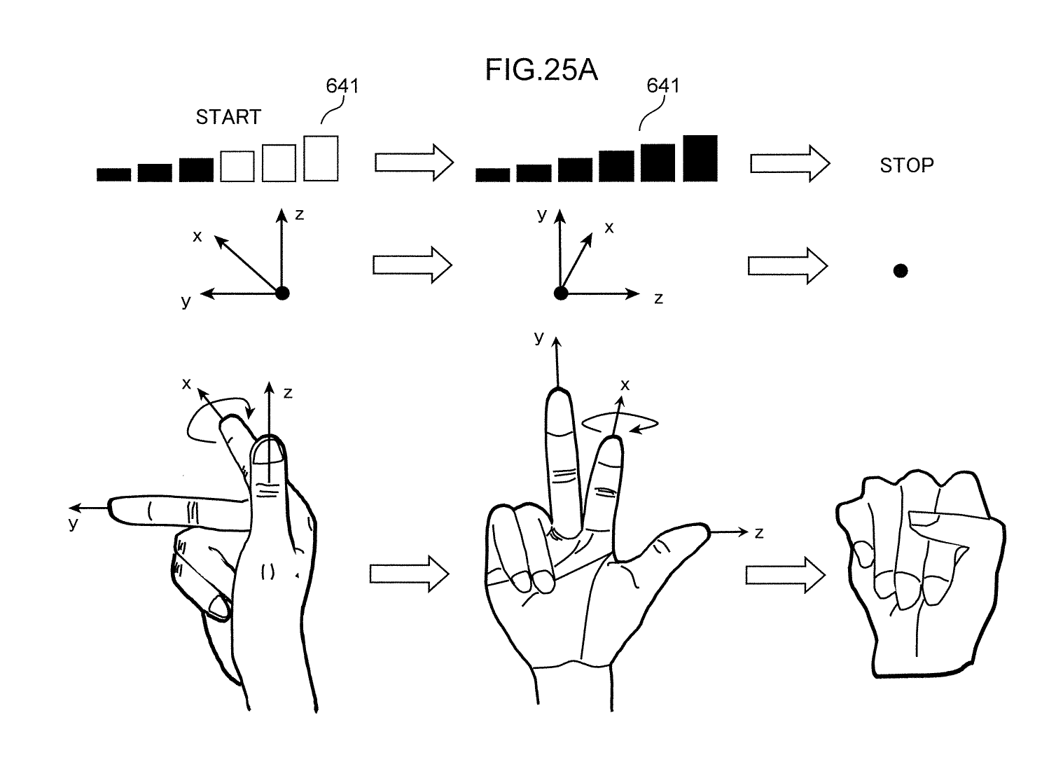

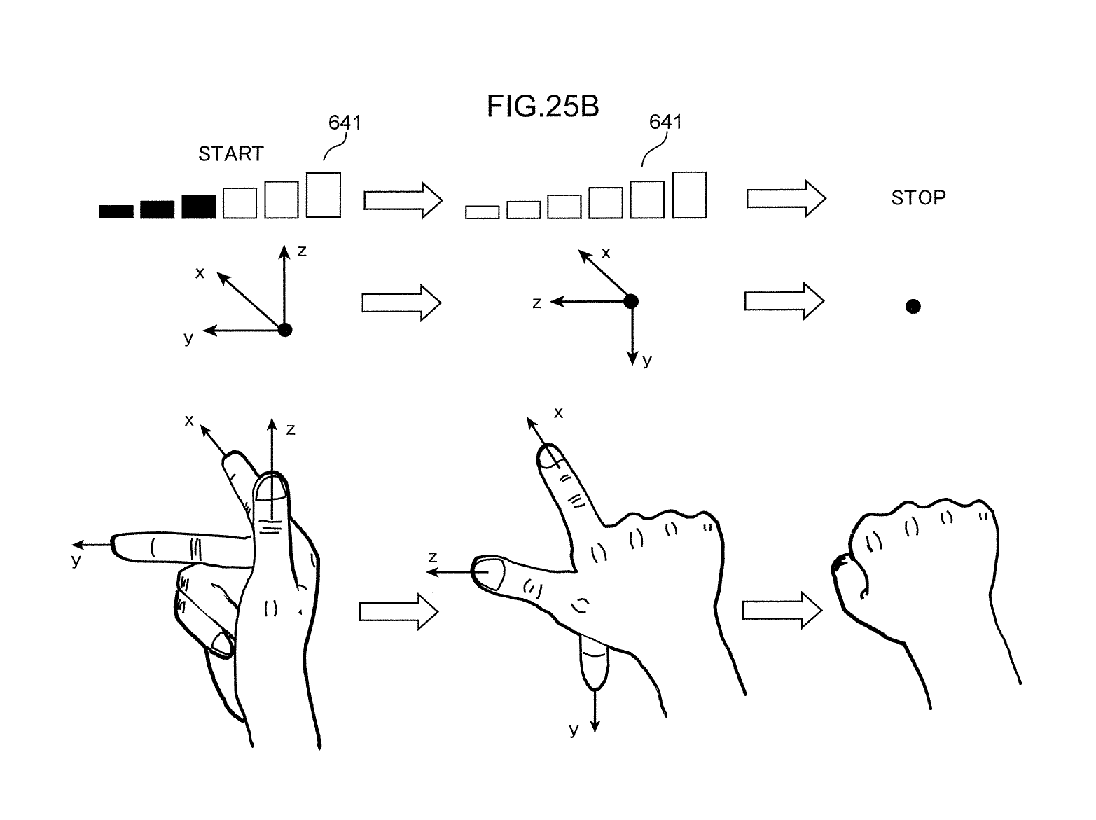

FIG. 25A shows an exemplary gesture pattern to increase a heating level. FIG. 25B shows another exemplary gesture pattern to decrease a heating level. The gesture patterns for adjusting the heating level are described with reference to FIGS. 24A to 25B.

The operator may make a hand gesture to define a three-dimensional coordination system at first. The straight index finger extending toward the sensor 200 defines x-axis. The straight middle finger directing leftward defines y-axis. The straight thumb directing upward defines z-axis. The processing unit 300 recognizes the three-dimensional coordination system defined by the right hand of the operator. If the processing unit 300 recognizes y-axis extending leftward and/or z-axis extending upward, the processing unit 300 processes a hand gesture depicted in image data from the sensor 200 as the start gesture.

When the operator twists the wrist clockwise by around 90 degrees, the three-dimensional coordination system defined by the right hand of the operator turns around x-axis clockwise by around 90 degrees. When the operator twists the wrist counterclockwise by around 90 degrees, the three-dimensional coordination system defined by the right hand of the operator turns around x-axis counterclockwise by around 90 degrees. The processing unit 300 recognizes the rotational motion of the three-dimensional coordination system.

The processing unit 300 identifies a rotational direction of the three-dimensional coordination system from the image data output from the sensor 200. If the recognized three-dimensional coordination system rotates clockwise, the processing unit 300 may start a control to increase a heating level. If the recognized three-dimensional coordination system rotates counterclockwise, the processing unit 300 may start a control to decrease a heating level.

The processing unit 300 identifies how much the three-dimensional coordination system rotates. If the three-dimensional coordination system rotates by a small angle, the processing unit 300 changes a heating level slightly. If the three-dimensional coordination system rotates by a large angle, the processing unit 300 changes a heating level largely.

A change amount of the heating level may depend on a difference between the current heating level (when the operator makes the start gesture) and the maximum or minimum heating level. As shown in FIGS. 25A and 25B, the left indicator 641 emits light from three of six indication windows when the operator makes the start gesture. If the operator twists the wrist clockwise by around 90 degrees, the processing unit 300 increases a heating level to the maximum level. In this case, the left indicator 641 emits light from all the indication windows. If the operator twists the wrist counterclockwise by around 90 degrees, the processing unit 300 decreases a heating level to the minimum or turns off a heater for the left heating area 621. In this case, there are no indication windows emitting light. If the operator twists the wrist clockwise by around 60 degrees, the processing unit 300 increases a heating level so that the left indicator 641 emits light from five of the six indication windows. If the operator twists the wrist counterclockwise by around 60 degrees, the processing unit 300 decreases a heating level so that the left indicator 641 emits light from one of the six indication windows. If the operator twists the wrist clockwise by around 30 degrees, the processing unit 300 increases a heating level so that the left indicator 641 emits light from four of the six indication windows. If the operator twists the wrist counterclockwise by around 30 degrees, the processing unit 300 decreases a heating level so that the left indicator 641 emits light from two of six windows.

After appropriate adjustment to the heating level, the operator may close the hand to complete the gesture pattern. If the operator closes the hand, the processing unit 300 recognizes no three-dimensional coordination system from image data output from the sensor 200. When no three-dimensional coordination system is recognized, the processing unit 300 determines that an input action of the operator completes, and then starts the next processes such as heating process for the left heating area 621.

### Ninth Embodiment

In the fourth embodiment, when the determined operation command has been cancelled during the feedback operation, the overall process is ended. To operate the input device 100, the operator has to input a gesture for a required correct operation from the start of the input process again. Hence, required operation or work may not be done smoothly. To solve the problem, the ninth embodiment generates an alternative operation command after the firstly determined operation command has been cancelled. The alternative operation command may relate to the cancelled operation command.

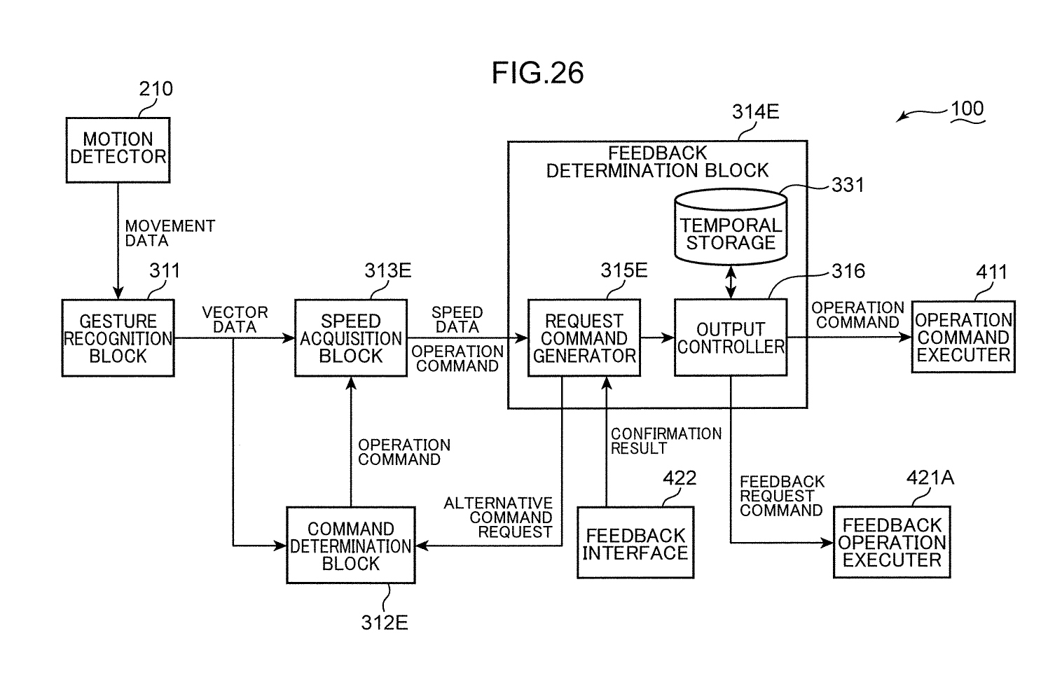

FIG. 26 is another exemplary functional block diagram of the input device 100. The functional block diagram is designed on the basis of the technical concepts described in the context of the first embodiment. Functions of the input device 100 are described in the context of the ninth embodiment with reference to FIG. 26. It should be noted that the commonly used numerals between FIGS. 10 and 26 mean that elements labeled with the common numerals have the same functions as the fourth embodiment. Therefore, the description in the fourth embodiment is applied to these elements.

Like the fourth embodiment, the input device 100 includes the motion detector 210, the gesture recognition block 311, the output controller 316, the temporal storage 331, the operation command executer 411, the feedback operation executer 421 A, and the feedback interface 422. The input device 100 further includes a command determination block 312E, a speed acquisition block 313E, and a request command generator 315E.

Like the fourth embodiment, the command determination block 312E determines a specific operation command owing to vector data received from the gesture recognition block 311. On the other hand, the command determination block 312E determines an alternative operation command when there is an alternative command request from the request command generator 315E. The alternative operation command may be determined owing to the relation to the firstly determined operation command.

Like the fourth embodiment, the speed acquisition block 313E generates speed data from the vector data. On the other hand, when the operation command sent from the command determination block 312E is the alternative operation command, the speed acquisition block 313E may not generate speed data. The speed acquisition block 313E just passes the alternative operation command to the request command generator 315E.

Like the fourth embodiment, the request command generator 315E determines whether a feedback operation is required or not on the basis of the speed data and the operation command. On the other hand, when the firstly determined operation command was cancelled, the request command generator 315E generates alternative command request to the command determination block 312E. In addition, when the operation command input at the request command generator 315E is the alternative operation command, the request command generator 315E performs feedback operation since the alternative operation command is the predicted command and has to be confirmed by the operator before execution.

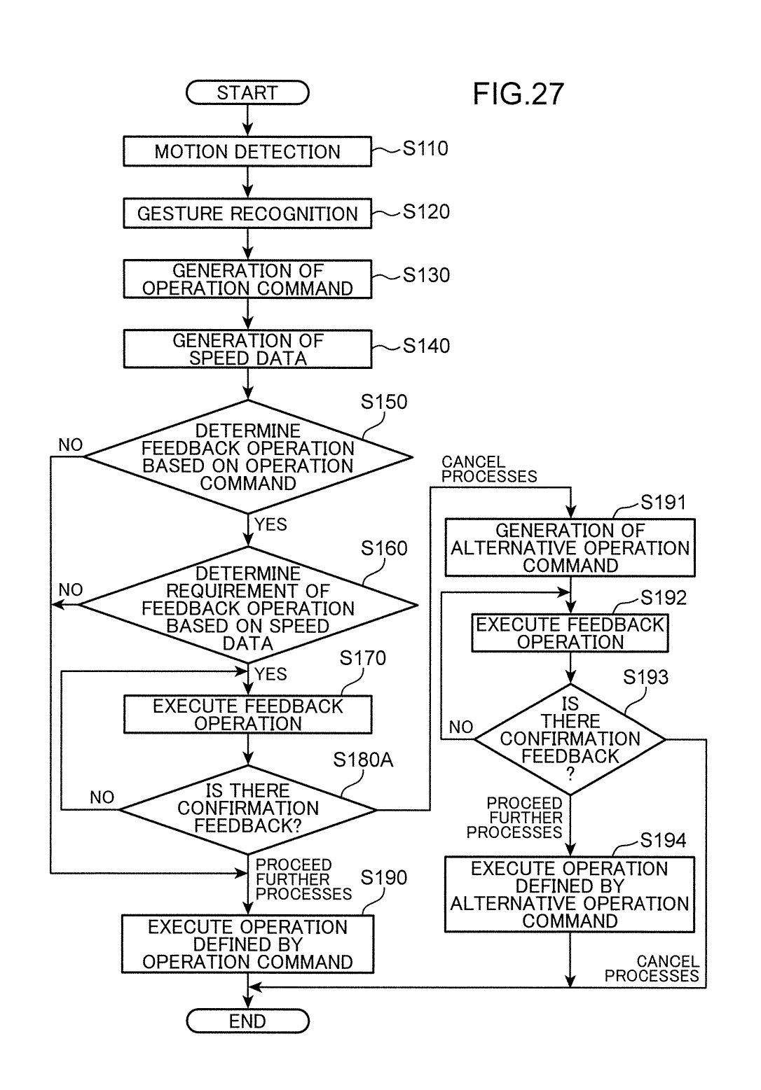

FIG. 27 is a schematic flowchart of processes of the input device 100. The flowchart is designed on the basis of the configuration described with reference to FIG. 26. The processes of the input device 100 are described with reference to FIGS. 26 and 27. It should be noted that the flowchart in FIG. 27 is just exemplary. Therefore, the input device 100 may execute various subsidiary processes in addition to the steps in FIG. 27.

### (Step S110)

In step S110, the motion detector 210 detects movement of a body part of an operator. The motion detector 210 then generates image data as the movement data representing the motion of the operator. The image data is output from the motion detector 210 to the gesture recognition block 311. After that, step S120 is executed.

### (Step S120)

In step S 120, the gesture recognition block 311 recognizes a part of data as data of the body part and generates vector data from the recognized data part. The vector data is sent from the gesture recognition block 311 to the command determination block 312E and the speed acquisition block 313E. After that, step S130 is executed.

### (Step S130)

In step S130, the command determination block 312E determines an operation command on the basis of the vector data. The operation command generated by the command determination block 312E is then output to the speed acquisition block 313E. After that, step S140 is executed.

### (Step S140)

In step S140, the speed acquisition block 313E generates speed data representing a speed of the body part from the vector data. The speed acquisition block 313E outputs the speed data and the operation command to the request command generator 315E. After that, step S150 is executed.

### (Step S150)

In step S150, the request command generator 315E refers the operation command and determines whether an operation defined by the operation command requires a feedback operation. If the operation requires a feedback operation, step S160 is executed. Otherwise, step S190 is executed.

### (Step S160)

In step S160, the request command generator 315E compares a speed represented by the speed data with a threshold. If the speed is lower than the threshold, the request command generator 315E determines that a feedback operation is required. The request command generator 315E then generates a feedback request command. The feedback request command is output from the request command generator 315E to the feedback operation executer 421A through the output controller 316. The operation command is output from the request command generator 315E to the temporal storage 331 through the output controller 316. After that, step S170 is executed. Unless the speed is lower than the threshold, the request command generator 315E determines that no feedback operation is required. The request command generator 315E outputs the operation command to the operation command executer 411 through the output controller 316. After that, step S190 is executed.

### (Step S170)

In step S170, the feedback operation executer 421 A executes the feedback operation in response to the feedback request command. Accordingly, the operator may confirm whether the input device 100 receives an operational request from the operator appropriately or not. After that, step S180 is executed.

### (Step S180)

In step S180, the request command generator 315E waits for a feedback input from the operator. If the operator operates the feedback interface 422 to request further processes, step S190 is executed. If the operator operates the feedback interface 422 to cancel processes, step S191 is executed.

### (Step S190)

In step S190, the operation command executer 411 executes a predetermined operation in response to the operation command.

### (Step S191)

In step S191, the request command generator 315E generates an alternative command request and output the request to the command determination block 312E. Then, the command determination block 312E determines an alternative operation command based on the firstly determined operation command, which has been cancelled by the operator. The alternative operation command is then output to the speed acquisition block 313E. The speed acquisition block 313E passes the alternative operation command to the request command generator 315E. After receiving the alternative operation command, the request command generator 315E generates a feedback request command owing to the alternative operation command. The feedback request command is output from the request command generator 315E to the feedback operation executer 421A through the output controller 316. The alternative operation command is output from the request command generator 315E to the temporal storage 331 through the output controller 316. After that, step S192 is executed.

### (Step S192)

In step S192, the feedback operation executer 421 A executes the feedback operation in response to the feedback request command owing to the alternative operation command. Accordingly, the operator may confirm whether the input device 100 predicted an alternative operation command appropriately or not. After that, step S193 is executed.

### (Step S193)

In step S193, the request command generator 315E waits for a feedback input from the operator. If the operator operates the feedback interface 422 to request further processes, step S194 is executed. If the operator operates the feedback interface 422 to cancel processes, the input device 100 stops process.

### (Step S194)

In step S194, the operation command executer 411 executes a predetermined operation in response to the alternative operation command.

An exemplary use case of the ninth embodiment may be illustrated by usage of an IH cooking heater that can receive an order from its operator by an air gesture. In the case that an operator wanted to decrease a heating level of the IH cooking heater, but the operator wrongly performed a gesture that results in an operation command for increasing the heating level.

Accordingly, the operator cancelled the operation command for increasing the heating level. After cancellation, a processing unit of the IH cooking heater predicts an alternative operation command which relates to the cancelled operation command for increasing a heating level. If an alternative operation command predicting algorithm is to choose the opposite command to the cancelled operation command, the processing unit of the IH cooking heater may predict an alternative operation command to decrease the heating level, and the operator may confirm the alternative operation command for execution. As a result, the operator does not have to start inputting a gesture from the start again, and a cooking process can be continued smoothly.

In predicting an alternative operation command, various algorithms such as selecting an opposite command (increase/decrease), selecting a command that has the most similar gesture, and selecting a command that is mostly used owing to the present system condition may be used.

### Tenth Embodiment

In ninth embodiment, when the firstly determined operation command was cancelled, an alternative operation command is predicted owing to relation with the firstly determined operation command without using speed data. However, the prediction may be improved by including information from the speed data.

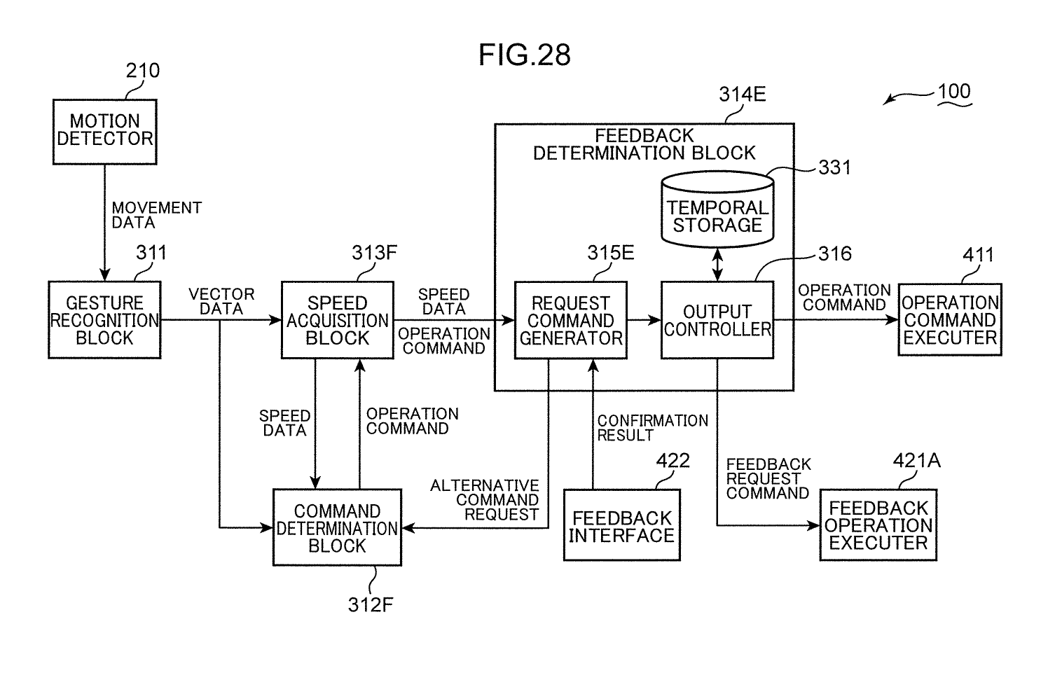

FIG. 28 is another exemplary functional block diagram of the input device 100. The functional block diagram is designed on the basis of the technical concepts described in the context of the first embodiment. Functions of the input device 100 are described in the context of the tenth embodiment with reference to FIG. 28. It should be noted that the commonly used numerals between FIGS. 26 and 28 mean that elements labeled with the common numerals have the same functions as the ninth embodiment. Therefore, the description in the ninth embodiment is applied to these elements.

Like the ninth embodiment, the input device 100 includes the motion detector 210, the gesture recognition block 311, the feedback determination block 314E, the operation command executer 411, the feedback operation executer 421A, and the feedback interface 422. The input device 100 further includes a command determination block 312F, and a speed acquisition block 313F.

Like the ninth embodiment, the command determination block 312F determines a specific operation command owing to a vector data received from the gesture recognition block 311, and determines an alternative operation command when there is an alternative command request from the request command generator 315E. On the other hand, the command determination block 312F may receive speed data from the speed acquisition block 313F when the alternative command request was input to the command determination block 312F. The alternative operation command may be determined owing to the firstly determined operation command, the vector data and the speed data.

Like the ninth embodiment, the speed acquisition block 313F generates speed data from the vector data. On the other hand, the speed acquisition block 313F may output the speed data to the command determination block 312F when the command determination block 312F predicts an alternative operation command.

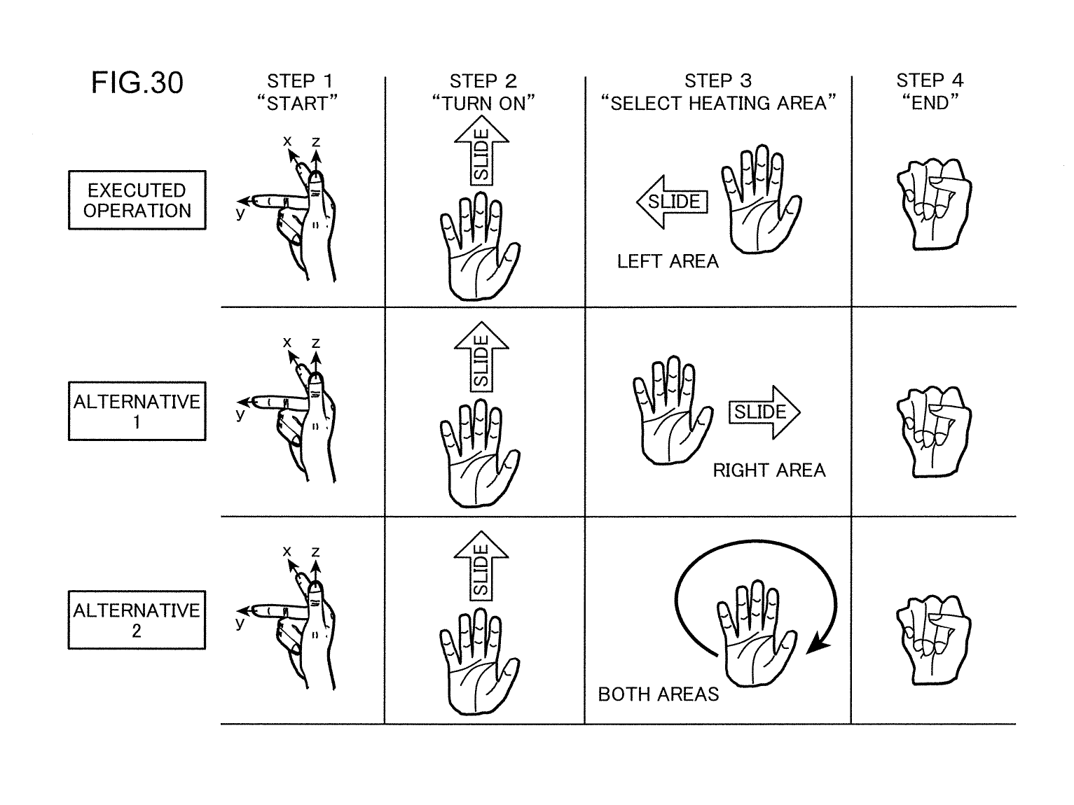

The aforementioned configuration may be incorporated into various apparatuses for improving alternative operational command prediction. In the tenth embodiment, an IH cooking heater is described as an exemplary apparatus that employs the aforementioned configuration. The following description will refer to FIGS. 24A, 29 and 30.

FIG. 24A is a schematic perspective view of a cooking heater 600. It should be noted that the details of the cooking heater 600 is described in the description of the eight embodiment.

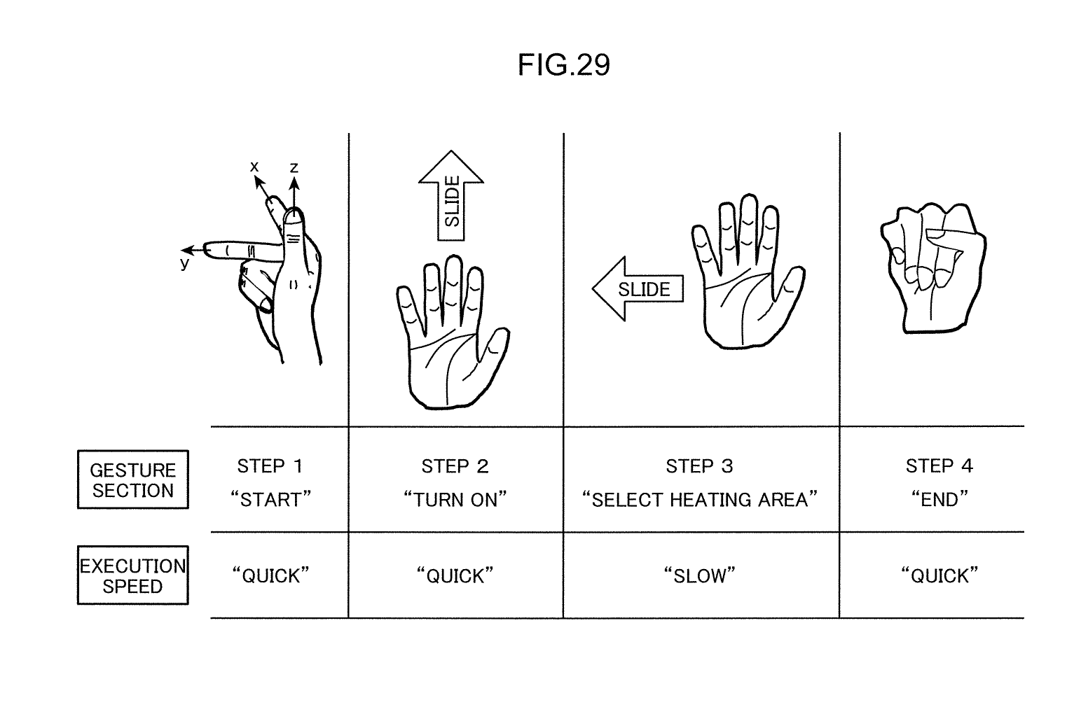

FIG. 29 illustrates an exemplary gesture pattern for turning on a heating area of the cooking heater 600.

An operator of the cooking heater 600 might slowly perform the gesture pattern illustrated in FIG. 29 with expectation to turn on both heating areas 621, 622 inside the cooking heater 600. The pattern is divided into 4 steps including “start”, “Turn On”, “Select Heating Area” and “End”. However, the performed gesture pattern matches to a command for tuning on a left heating area 621 only. Hence, the operator cancelled the firstly determined operation command. According to the configuration in FIG. 28, a processing unit inside the cooking heater 600 considered prediction of an alternative operation command using speed data. In prediction of the alternative operation command, the speed data of each step inside the gesture pattern was used. Owing to the speed data illustrated in FIG. 29, it was learned that the 3^{rd} step inside the gesture pattern was performed slowly. Thus, it could be predicted that the 3^{rd} step should have high possibility of incorrect gesture. The processing unit then considered alternative patterns. The alternative patterns might be considered to be the patterns which have the same gesture in the 1^{st}, 2^{nd} and 4^{th} steps to the performed gesture pattern since the 3^{rd} step was assumed to be wrong.

By the aforementioned exemplary use case, using the speed data of each step inside the performed gesture pattern may increase possibility that the selected alternative operation command will match the operator's expectation.

It should also be noted that other selection method for possible alternative gesture patterns and commands is not limited to the algorithm illustrated in the aforementioned exemplary use case. For example, the firstly determined command may be used to refine the possible gesture patterns when there are various possible gestures patterns with different operation aspects such as “turn on/off” or “adjusting level”.

The technologies described in the context of the ninth and tenth embodiments may provide an alternative operation command related to a former determined command when the former determined command was cancelled by the operator during a feedback process.

The input devices described in the context of the ninth and tenth embodiments provide feedback for confirming an operation command before execution to an operator when the operator slowly performed a gesture, and waits for execution confirmation or cancellation for the operation command from the operator before proceed to the next step.

Therefore, the operation command owing to a slowly performed gesture may be confirmed before execution. Accordingly, a system that employs the technologies described in the context of the ninth and tenth embodiments may have high stability in performing operation by an air gesture.

The input devices described in the context of the ninth and tenth embodiments provide an alternative operation command after the firstly determined operation command is cancelled by an operator during the command confirmation process. The alternative operation command may be selected from a set of commands that is related or closed to the firstly determined operation command. For example, an operator who is not skilled in a gesture operation performed an air gesture slowly, and thus the input device determined that confirmation feedback was required. During a feedback process, the operator cancelled the firstly determined operation command since it was incorrect. The firstly determined operation command was to increase a radio volume while the operator wanted to decrease the volume. Therefore, the input device predicts an alternative command from a set of commands related to the volume-increasing command, and then gives an operator an alternative operation command. If the prediction algorithm is to find the opposite operation command to the firstly determined operation command, an operation command for decreasing the radio volume may be chosen as the alternative operation command.

According to the technologies described in the context of the ninth and tenth embodiments, the operator may not need to input a corrected gesture again from the start point when the operator performed a wrong gesture, and thus the operation can be done smoothly.

The principles of the aforementioned various embodiments may be applied to gesture recognition on a touch-sensitive device such as a touch pad or a touch screen. Accordingly, the principles of the aforementioned various embodiments may be applied to various input devices.

The exemplary technologies for inputting operational requests described in the aforementioned various embodiments mainly include the following features.

The input device according to one aspect of the aforementioned embodiments includes a sensor configured to track movement of a body part of an operator and generate movement data about the movement of the body part, a processor including an operation command generator configured to generate an operation command from the movement data, a speed data generator configured to generate speed data representing a speed of the movement from the movement data, and a feedback determination portion configured to determine whether a feedback operation to allow the operator to confirm the operation command is required based on the speed data, and an operation portion including a feedback operation device configured to execute the feedback operation if the feedback determination portion determines that the feedback operation is required.

According to the aforementioned configuration, the feedback determination portion determines whether the feedback operation is required on the basis of the speed data. Since the speed data represents a speed of the movement of the body part of the operator, the determination of the feedback determination portion depends on the speed of the movement of the body part of the operator. Therefore, the operator may change a speed of the body part to select whether the feedback operation device executes the feedback operation.

In the aforementioned configuration, the sensor may generate image data of the movement as the movement data. The processor may include a recognition portion configured to recognize and extract gesture data from the image data. The gesture data may be used for generation of the operation command and the speed data.

According to the aforementioned configuration, since the gesture data is used for generation of the operation command and the speed data, the operator may move the body part and make a gesture to give the input device an instruction. Meanwhile, the operator may change a speed of the body part to select whether the feedback operation device executes the feedback operation.

In the aforementioned configuration, the operation portion may include a command execution device configured to execute a predetermined operation in response to the operation command. The feedback operation device may execute notification operation to give the operator operation information about the predetermined operation defined by the operation command.

According to the aforementioned configuration, the operator may move the body part so as to make the command execution device execute a predetermined operation. Meanwhile, the operator may change a speed of the body part to select whether the feedback operation device executes the feedback operation.

In the aforementioned configuration, the feedback determination portion may compare the speed data with a threshold to determine whether the feedback operation is required. The operation portion may execute the feedback operation if the speed data shows a lower speed than the threshold. The operation portion may execute a predetermined operation in response to the operation command without executing the feedback operation unless the speed data shows a lower speed than the threshold.

According to the aforementioned configuration, if the operator moves the body part at a lower speed than the threshold, the operation portion may execute the feedback operation. Otherwise, the operation portion may execute a predetermined operation in response to the operation command without executing the feedback operation. Therefore, the input device may selectively execute the feedback operation.

In the aforementioned configuration, the feedback determination portion may include a feedback candidate storage configured to store feedback candidate data about the feedback operation. The feedback candidate data may be associated with the operation command.

According to the aforementioned configuration, since the feedback candidate data stored in the feedback candidate storage is associated with the operation command, the input device may be variously and/or accurately controlled on the basis of a relationship between the feedback candidate data and the operation command.

In the aforementioned configuration, the feedback determination portion may select a first feedback operation from the feedback candidate data if the operation command defines a first operation. The feedback determination portion may select a second feedback operation, which is different from the first feedback operation, from the feedback candidate data if the operation command defines a second operation different from the first operation.

According to the aforementioned configuration, the feedback operation device may selectively execute the first or second feedback operation in response to the operation command.

In the aforementioned configuration, if the operation command is irrelevant to the feedback candidate data, the operation portion may execute a predetermined operation in response to the operation command without executing the feedback operation.

According to the aforementioned configuration, since the operation portion executes a predetermined operation without executing the feedback operation if the operation command is irrelevant to the feedback candidate data, the operator may make the operation portion execute the predetermined operation without waiting for the feedback operation of the feedback operation device.

In the aforementioned configuration, the operation command may include an identifier representing whether the feedback operation is required. The operation portion may execute the feedback operation if the identifier instructs that the feedback operation is required. The operation portion may execute a predetermined operation in response to the operation command without executing the feedback operation if the identifier instructs no requirement of the feedback operation.

According to the aforementioned configuration, since the identifier is used for determining whether the feedback operation is required, in addition to the speed data, the input device may be accurately controlled.

In the aforementioned configuration, if the identifier instructs that the feedback operation is required, the operation command may be sent to the feedback determination portion. The feedback determination portion may determine whether the feedback operation is required based on the speed data in response to reception of the operation command.

According to the aforementioned configuration, since the identifier is used for determining whether the feedback operation is required, in addition to the speed data, the input device may be accurately controlled.

In the aforementioned configuration, if the identifier instructs no requirement of the feedback operation, the operation command may be sent to the operation portion without passing through the feedback determination portion.

According to the aforementioned configuration, since the operation command is sent to the operation portion without passing through the feedback determination portion if the identifier instructs no requirement of the feedback operation, the operation portion may execute a predetermined operation without redundant processes for the operation command.

In the aforementioned configuration, the operation command generator may determine whether the identifier instructs that the feedback operation is required or the identifier instructs no requirement of the feedback operation based on the movement data.

According to the aforementioned configuration, the input device may selectively execute the feedback operation since it depends on the movement of the body part whether the identifier instructs that the feedback operation is required or the identifier instructs no requirement of the feedback operation.

In the aforementioned configuration, the identifier may be editable.

According to the aforementioned configuration, since the identifier is editable, the input device is suitably adjusted for a usage environment.

In the aforementioned configuration, the recognition portion may extract data representing a hand of the operator as the gesture data if the hand defines a three-dimensional coordination system.

According to the aforementioned configuration, the operation command generator may use the three-dimensional coordination system defined by the hand to generate the operation command. The speed data generator may also use the three-dimensional coordination system to generate the speed data. Since the three-dimensional coordination system is shared by generation of the operation command and the speed data, the movement of the body part may be appropriately reflected to the operation command and the speed data.

In the aforementioned configuration, the three-dimensional coordination system may include a first axis defined by a straight finger of the hand, a second axis defined by another straight finger of the hand, and a third axis defined by at least one of remaining fingers which is stretched straight. Angles between the first and second axes, between the second and third axes and between the third and first axes may be ranged from 70 to 120 degrees, respectively.

According to the aforementioned configuration, since the angles between the first and second axes, between the second and third axes and between the third and first axes is ranged from 70 to 120 degrees, respectively, the recognition portion is less likely to recognize the gesture data unless the operator intentionally forms the three-dimensional coordination system by hand. Therefore, the input device is less likely to erroneously generate the operation command and/or the speed data.

In the aforementioned configuration, the feedback operation device may execute a notification operation to give the operator operation information about the predetermined operation defined by the operation command.

According to the aforementioned configuration, the operator may know whether the operator has input accurate information to the input device when the operator receives the operation information from the feedback operation device executing the notification operation.

In the aforementioned configuration, the command execution device may execute the predetermined operation a predetermined delay period after the feedback operation device gives the operation information.

According to the aforementioned configuration, there is a delay period after the feedback operation device gives the operation information, the operator may cancel a request input to the input device during the delay period before the command execution device starts the predetermined operation.

In the aforementioned configuration, the sensor may include a touch-sensitive device configured to generate the movement data in response to the body part touching the touch-sensitive device. The processor may include a recognition portion configured to recognize and extract gesture data from the movement data. The gesture data may be used for generation of the operation command and the speed data.

According to the aforementioned configuration, a user may use various touch-sensitive devices to input operational requests.

In the aforementioned configuration, the operation portion may include a feedback interface device configured to receive a confirmation result of the feedback operation from the operator. The confirmation result may be confirmative for executing the operation command or cancellation of the operation command.

According to the aforementioned configuration, a user may input operational request accurately.

In the aforementioned configuration, if the confirmation result instructs that the operation command is to be executed, the operation portion may execute a predetermined operation in response to the operation command.

According to the aforementioned configuration, the operation portion may operate appropriately in response to an operational request from a user.

In the aforementioned configuration, if the confirmation result instructs that the operation command is cancelled, the operation command generator may generate an alternative operation command without receiving new movement data from the sensor.

According to the aforementioned configuration, since the operation command generator generates an alternative operation command without receiving new movement data from the sensor, a user may input an operational request smoothly.

In the aforementioned configuration, the feedback determination portion may determine that a feedback operation in response to the alternative operation command is required. The operation portion may execute the feedback operation in response to the alternative operation command.

According to the aforementioned configuration, since the operation portion executes the feedback operation in response to the alternative operation command, a user may determine whether an alternative operation command is appropriate.

In the aforementioned configuration, the speed data may be used by the operation command generator to generate the alternative operation command.

According to the aforementioned configuration, since the speed data is used by the operation command generator to generate the alternative operation command, the operation portion may generate an alternative operation command accurately.

In the aforementioned configuration, the operation command generator may generate the alternative operation command only 1 time after cancellation of the operation command.

According to the aforementioned configuration, since the operation command generator generates the alternative operation command only 1 time after cancellation of the operation command, a user may input an operational request smoothly.

In the aforementioned configuration, the operation command generator may generate the alternative operation command only 2 times after each cancellation of the operation command and a former alternative operation command.

According to the aforementioned configuration, since the operation command generator generates the alternative operation command only 2 times after each cancellation of the operation command and a former alternative operation command, a user may input an operational request smoothly.

The method according to another aspect of the aforementioned embodiments is used for inputting an operational request. The method includes steps of tracking movement of a body part of an operator to generate movement data about the movement of the body part, generating an operation command defining a predetermined operation and speed data representing a speed of the movement from the movement data, determining whether a feedback operation to allow the operator to confirm the operation command is required based on the speed data, and executing the feedback operation if the feedback operation is required.

According to the aforementioned configuration, it is determined on the basis of the speed data whether the feedback operation is required. Since the speed data represents a speed of the movement of the body part of the operator, the determination depends on the speed of the movement of the body part of the operator. Therefore, the operator may change a speed of the body part to select whether the feedback operation device executes the feedback operation.

In the aforementioned configuration, the method may further include a step of executing the predetermined operation in response to the operation command.

According to the aforementioned configuration, the operator may move the body part so as to obtain a predetermined operation. Meanwhile, the operator may change a speed of the body part to select whether the feedback operation is executed.

### INDUSTRIAL APPLICABILITY

The principles of the aforementioned various embodiments may be utilized for various apparatuses configured to operate in response to operational requests from operators.

1. An input device, comprising:
a sensor configured to track movement of a body part of an operator and generate movement data about the movement of the body part,
a processor including an operation command generator configured to generate an operation command from the movement data, a speed data generator configured to generate speed data representing a speed of the movement from the movement data, and a feedback determination portion configured to determine whether a feedback operation to allow the operator to confirm the operation command is required based on the speed data, and
an operation portion including a feedback operation device configured to execute the feedback operation if the feedback determination portion determines that the feedback operation is required.

2. The input device according to claim 1, wherein
the sensor generates image data of the movement as the movement data,
the processor includes a recognition portion configured to recognize and extract gesture data from the image data,
the gesture data is used for generation of the operation command and the speed data.

3. The input device according to claim 1, wherein
the sensor includes a touch-sensitive device configured to generate the movement data in response to the body part touching the touch-sensitive device,
the processor includes a recognition portion configured to recognize and extract gesture data from the movement data, and
the gesture data is used for generation of the operation command and the speed data.

4. The input device according to claim 1, wherein
the operation portion includes a command execution device configured to execute a predetermined operation in response to the operation command, and
the feedback operation device executes notification operation to give the operator operation information about the predetermined operation defined by the operation command.

5. The input device according to claim 1, wherein
the feedback determination portion compares the speed data with a threshold to determine whether the feedback operation is required,
the operation portion executes the feedback operation if the speed data shows a lower speed than the threshold, and
the operation portion executes a predetermined operation in response to the operation command without executing the feedback operation unless the speed data shows a lower speed than the threshold.

6. The input device according to claim 1, wherein
the feedback determination portion includes a feedback candidate storage configured to store feedback candidate data about the feedback operation, and
the feedback candidate data is associated with the operation command.

7. The input device according to claim 6, wherein
the feedback determination portion selects a first feedback operation from the feedback candidate data if the operation command defines a first operation, and
the feedback determination portion selects a second feedback operation, which is different from the first feedback operation, from the feedback candidate data if the operation command defines a second operation different from the first operation.

8. The input device according to claim 6, wherein
if the operation command is irrelevant to the feedback candidate data, the operation portion executes a predetermined operation in response to the operation command without executing the feedback operation.

9. The input device according to claim 1, wherein,
the operation command includes an identifier representing whether the feedback operation is required,
the operation portion executes the feedback operation if the identifier instructs that the feedback operation is required, and
the operation portion executes a predetermined operation in response to the operation command without executing the feedback operation if the identifier instructs no requirement of the feedback operation.

10. The input device according to claim 9, wherein
if the identifier instructs that the feedback operation is required, the operation command is send to the feedback determination portion, and
the feedback determination portion determines whether the feedback operation is required based on the speed data in response to reception of the operation command.

11. The input device according to claim 9, wherein
if the identifier instructs no requirement of the feedback operation, the operation command is sent to the operation portion without passing through the feedback determination portion.

12. The input device according to claim 9, wherein
the operation command generator determines whether the identifier instructs that the feedback operation is required or the identifier instructs no requirement of the feedback operation based on the movement data.

13. The input device according to claim 9, wherein
the identifier is editable.

14. The input device according to claim 2, wherein
the recognition portion extracts data representing a hand of the operator as the gesture data if the hand defines a three-dimensional coordination system.

15. The input device according to claim 1, wherein
the operation portion includes a feedback interface device configured to receive a confirmation result of the feedback operation from the operator, and
the confirmation result is confirmative for executing the operation command or cancellation of the operation command.

16. The input device according to claim 15, wherein
if the confirmation result instructs that the operation command is to be executed, the operation portion executes a predetermined operation in response to the operation command.

17. The input device according to claim 15, wherein
if the confirmation result instructs that the operation command is cancelled, the operation command generator generates an alternative operation command without receiving new movement data from the sensor.

18. The input device according to claim 17, wherein
the feedback determination portion determines that a feedback operation in response to the alternative operation command is required, and
the operation portion executes the feedback operation in response to the alternative operation command.

19. The input device according to claim 17, wherein
the speed data is used by the operation command generator to generate the alternative operation command.

20. The input device according to claim 17, wherein
the operation command generator generates the alternative operation command only 1 time after cancellation of the operation command.

21. The input device according to claim 17, wherein
the operation command generator generates the alternative operation command only 2 times after each cancellation of the operation command and a former alternative operation command.

22. A method for inputting an operational request comprising steps of:
tracking movement of a body part of an operator to generate movement data about the movement of the body part,
generating an operation command defining a predetermined operation and speed data representing a speed of the movement from the movement data,
determining whether a feedback operation to allow the operator to confirm the operation command is required based on the speed data, and
executing the feedback operation if the feedback operation is required.
